(19) United States
(12) Patent Application Publication
(10) Pub. No.: US 2025/0052853 A1
(43) Pub. Date: Feb. 13, 2025

(54) ELECTRONIC DEVICE AND METHOD FOR POSITIONING

(71) Applicant: Sony Group Corporation, Tokyo (JP)

(72) Inventors: Wei XU, Nanjing, Jiangsu (CN); Yurong QIAN, Nanjing, Jiangsu (CN); Tingting FAN, Beijing (CN); Chen SUN, Beijing (CN)

(73) Assignee: Sony Group Corporation, Tokyo (JP)

(21) Appl. No.: 18/718,887

(22) PCT Filed: Jan. 18, 2023
(86) PCT No.: PCT/CN2023/072754

§ 371 Date: Jun. 12, 2024

(30) Foreign Application Priority Data
Jan. 21, 2022 (CN) 202210072078.9

(51) Int. Cl. G01S 5/02; G01S 5/00; G01S 5/10

(52) U.S. Cl. CPC G01S 5/0273; G01S 5/0072; G01S 5/0218; G01S 5/10

(57) ABSTRACT

The present disclosure relates to an electronic device and a method for positioning. An electronic device used with a base station is disclosed, comprising a processing circuit configured to: cause a first set of intelligent surfaces to reflect a set of first reflected beams to be used for a first beam scanning with a user equipment (UE); cause a second set of intelligent surfaces to reflect a set of second reflected beams to be used for a second beam scanning with the UE, wherein the second set of intelligent surfaces is selected from the first set of intelligent surfaces, and a beam width for the set of second reflected beams is smaller than a beam width for the set of first reflected beams; and determine a position of the UE, based at least in part on a result of the second beam scanning.

### CLAIM OF PRIORITY

This application claims the priority to Chinese patent application with application number 202210072078.9, titled “ELECTRONIC DEVICE AND METHOD FOR POSITIONING”, filed on Jan. 21, 2022, the entire content of which is incorporated herein by reference.

### TECHNICAL FIELD

The present disclosure relates to a field of wireless communication, and in particular, to an electronic device and A method for intelligent surface-assisted positioning.

### BACKGROUND

High-accuracy positioning technology is a key technology for realizing integrated perception and smart cities in the future. Generally, positioning technology refers to technology that estimates geographical location of a receiver by measuring radio signals received by the receiver and processing measurement results using specific algorithms. Existing positioning technologies include satellite positioning, base station positioning, Wi-Fi positioning, etc. Existing positioning technologies are subject to various limitations and has large positioning errors.

In satellite positioning technology, since the position of a satellite is precisely known, a receiver may obtain a distance from the satellite to the receiver by measuring arrival time of a satellite signal. Then, a distance formula in a three-dimensional coordinate may be used to form at least 3 equations by means of at least 3 satellites. By solving an equation set composed of these equations, the position (X, Y, Z) of the receiver may be determined. However, satellite positioning is highly susceptible to the environment and the weather. In scenarios where satellite signals cannot arrive directly (for example, indoors, under a bridge, etc.) or in a bad weather (for example, rainy days, etc.), the accuracy of satellite positioning will be greatly reduced or even unavailable.

In base station positioning technology, a receiver may measure feature parameters of radio signals emitted by a base station (including time, reference signal received power (RSRP), angle, etc.), and calculate the position of the receiver with respect to the base station based on results of these measurements. Since the position of the base station is known, the position of the receiver may be obtained based on the position of the base station. However, the radio signals being measured are extremely susceptible to interference, which may lead to inaccurate measurement results and thus large positioning errors. For example, in indirect scenarios (for example, indoors, etc.), radio signals emitted by the base station is easily blocked, and the fading of the radio signals is very serious, resulting in low positioning accuracy.

In Wi-Fi positioning technology, a receiver may measure strengths of multiple received Wi-Fi signals. Based on the strengths of the Wi-Fi signals, distances from respective Wi-Fi access points to the receiver may be determined. Based on known positions of the multiple Wi-Fi access points, the position of the receiver may be calculated through a positioning algorithm. However, Wi-Fi access points may not be permanently fixed, which will have a great impact on positioning results and even cause errors. Moreover, quality of communication (e.g., transmit power) of the Wi-Fi access points may be unstable, making it difficult to ensure positioning accuracy.

Therefore, there is a need for devices and methods that are able to provide high-accuracy positioning.

### SUMMARY

The present disclosure provides an electronic device and a method for intelligent surface-assisted positioning. An intelligent surface may also be referred to as a Large Intelligent Surface (LIS). With the assistance of LIS, the electronic device and the method for positioning provided by the present disclosure may provide high-accuracy positioning and are applicable to a wide range of positioning scenarios.

One aspect of the present disclosure relates to an electronic device used with a base station. The electronic device comprises a processing circuit configured to: cause a first set of intelligent surfaces to reflect a set of first reflected beams, the set of first reflected beams being used for a first beam scanning with a user equipment (UE); cause a second set of intelligent surfaces to reflect a set of second reflected beams, the set of second reflected beams being used for a second beam scanning with the UE, wherein the second set of intelligent surface is selected from the first set of intelligent surfaces, and a beam width for the set of second reflected beams is smaller than a beam width for the set of first reflected beams; and determine a position of the UE based at least in part on a result of the second beam scanning.

Another aspect of the present disclosure relates to an electronic device used with a UE. The electronic device comprises a processing circuit configured to: receive a set of first reflected beams reflected from a first set of intelligent surfaces to perform a first beam scanning; receive a set of second reflected beams reflected from a second set of intelligent surfaces to perform a second beam scanning, wherein the second set of intelligent surfaces is selected from the first set of intelligent surfaces, and a beam width for the set of second reflected beams is smaller than a beam width for the set of first reflected beams; and acquire a position of the UE that is determined based at least in part on a result of the second beam scanning.

One aspect of the present disclosure relates to a method performed by an electronic device on a base station side, comprising: causing a first set of intelligent surfaces to reflect a set of first reflected beams, the set of first reflected beams being used for a first beam scanning with a user equipment (UE); causing a second set of intelligent surfaces to reflect a set of second reflected beams, the set of second reflected beams being used for a second beam scanning with the UE, wherein the second set of intelligent surfaces is selected from the first set of intelligent surfaces, and a beam width for the set of second reflected beams is smaller than a beam width for the set of first reflected beams; and determining a position of the UE based at least in part on a result of the second beam scanning.

Another aspect of the present disclosure relates to a method performed by an electronic device on a user equipment (UE) side, comprising: receiving a set of first reflected beams reflected from a first set of intelligent surfaces to perform a first beam scanning; receiving a set of second reflected beams reflected from a second set of intelligent surfaces to perform a second beam scanning, wherein the second set of intelligent surfaces is selected from the first set of intelligent surfaces, and a beam width for the set of second reflected beams is smaller than a beam width for the set of first reflected beams; and acquiring a position of the UE that is determined based at least in part on a result of the second beam scanning.

Another aspect of the present disclosure relates to a computer-readable storage medium having one or more instructions stored thereon, which, when executed by one or more processing circuits of an electronic device, cause the electronic device to perform any method as described in the present disclosure.

Another aspect of the present disclosure relates to a computer program product comprising a computer program which, when executed by a processor, implements any method as described in present disclosure.

### BRIEF DESCRIPTION OF THE DRAWINGS

The above and other purposes and advantages of the present disclosure will be further described below in conjunction with specific embodiments and with reference to the accompanying drawings. In the drawings, same or corresponding technical features or components will be indicated by same or corresponding reference numerals.

FIGS. 1A-1B illustrate two LIS use cases according to embodiments of the present disclosure.

FIG. 2 illustrates an exemplary block diagram of an electronic device according to an embodiment of the present disclosure.

FIG. 3 illustrates an exemplary flowchart of a LIS-assisted positioning method according to an embodiment of the present disclosure.

FIGS. 4A-4B illustrate schematic diagrams of a first positioning mode and a second positioning mode according to embodiments of the present disclosure, respectively.

FIG. 5 illustrates an exemplary flowchart of a method for selecting a positioning mode for a UE according to an embodiment of the present disclosure.

FIG. 6 illustrates an exemplary time-frequency resource scheduling of reflected beams according to an embodiment of the present disclosure.

FIGS. 7A-7C describe example embodiments of selecting a first set of LISs based on initial position information of a UE.

FIG. 7D describes an example embodiment of selecting a first set of LISs based on a position of an assisting UE.

FIGS. 8A-8B illustrate schematic diagrams of a first beam scanning according to embodiments of the present disclosure.

FIGS. 8C-8D illustrate schematic diagrams of a second beam scanning according to embodiments of the present disclosure.

FIG. 9 illustrates a schematic diagram of determining a position of a UE to be located based on a distance between the UE and an assisting UE according to an embodiment of the present disclosure.

FIG. 10 illustrates an exemplary flowchart of a LIS-assisted positioning method according to an embodiment of the present disclosure.

FIG. 11 is a block diagram showing a first example of a schematic configuration of a gNB to which the technology of the present disclosure may be applied.

FIG. 12 is a block diagram showing a second example of a schematic configuration of a gNB to which the technology of the present disclosure may be applied.

FIG. 13 is a block diagram showing an example of a schematic configuration of a communication device to which the technology of the present disclosure may be applied.

FIG. 14 is a block diagram showing an example of a schematic configuration of a vehicle navigation device to which the technology of the present disclosure may be applied.

While the embodiments described in the present disclosure may be susceptible to various modifications and alternative forms, specific embodiments thereof are shown by way of example in the drawings and described in detail herein. It should be understood, however, that the drawings and detailed description are not intended to limit the embodiments to the disclosed particular forms, but on the contrary, the intention is to cover all modifications, equivalents and alternatives that fall within the spirit and scope of the claims.

### DETAILED DESCRIPTION

Exemplary embodiments of the present disclosure will be described below with reference to the accompanying drawings. For the sake of clarity and conciseness, not all features of the embodiments are described in the specification. It should be understood, however, that many implementation-specific settings must be made in implementing an embodiment in order to achieve the developer's specific goals, for example, to meet those constraints associated with the device and business, and that these constraints may vary from one implementation to another. Moreover, it should also be understood that development work, while potentially very complex and time-consuming, would only be a routine undertaking for those skilled in the art having the benefit of the present disclosure.

Here, it should also be noted that in order to avoid obscuring the present disclosure with unnecessary details, only the processing steps and/or device structures that are closely related to at least the solution according to the present disclosure are shown in the drawings, while other details that are of little relevance to the present disclosure are omitted.

### 1. INTELLIGENT SURFACE

An intelligent surface may also be referred to as a Large Intelligent Surface (LIS). An LIS is an array composed of multiple reflective surfaces. Each reflective surface may be a low-cost passive reflective element. Each reflective surface in the array may reflect a radio signal incident onto the LIS. The resulting reflected signal may be received by a target device. Therefore, the LIS may provide one or more communication paths in the wireless communication environment, in addition to a direct path between the source and the target device of the radio signal. In many scenarios, the direct path between the source and the target device of the radio signal may be unavailable or has low quality of communication (e.g., because there are obstacles between the source and the target device). The communication paths provided by LIS may provide alternative paths or supplementary paths, thereby improving reachability and reliability of the wireless communication. Since LIS has characteristics of low cost and low power consumption, LIS is particularly suitable for widely distribution in the communication environment.

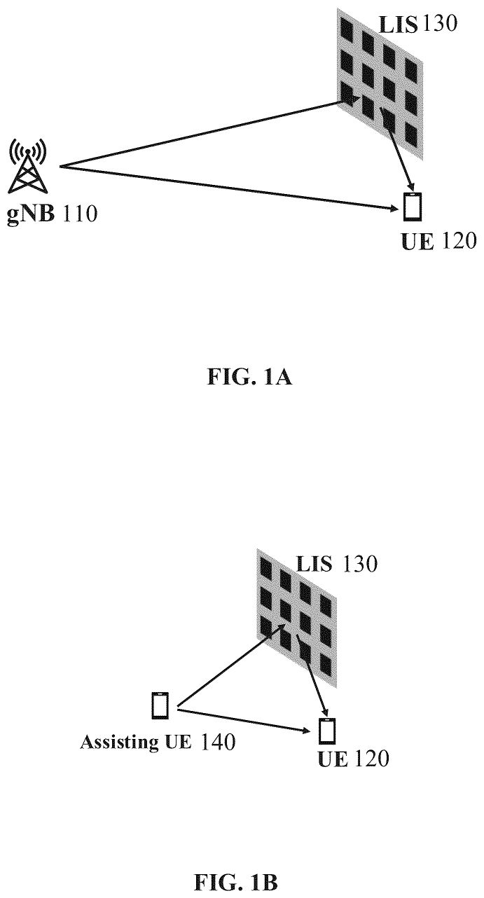

FIGS. 1A-1B illustrate two LIS use cases according to embodiments of the present disclosure. It should be understood that the illustrated two LIS use cases are exemplary only. In other embodiments, other LIS use cases may exist without limitation.

In a use case shown in FIG. 1A, LIS 130 may be configured to reflect a radio signal transmitted by a base station (e.g., gNB) 110. The base station 110 may transmit the radio signal directly to UE 120. Advantageously, the base station 110 may transmit the radio signal also to the LIS 130, and then the UE 120 may receive the radio signal reflected from the LIS 130. With LIS 130, an additional radio path may be formed between the base station 110 and the UE 120.

In a use case shown in FIG. 1B, the LIS 130 may also be configured to reflect a radio signal from other devices. As shown, the LIS 130 may be configured to reflect a radio signal from another UE 140 and the reflected radio signal may be received by the UE 120. The UE 140 may also communicate directly with the UE 120. For example, the UE 140 may exchange a radio signal directly with the UE 120 through a sidelink. In this way, multiple radio paths may be formed between the UE 140 and the UE 120.

A reflected signal reflected by the LIS may form one or more reflected beams. Specifically, a reflective surface of the LIS may adjust properties (e.g., amplitude, phase) of an incident radio signal, thereby producing an adjusted reflected signal. One or more reflective surfaces of the LIS may be configured such that a radio signal reflected by each of the one or more reflective surfaces has a specified direction, a specified amplitude, and/or a specified phase. A plurality of radio signals reflected by multiple reflective surfaces of the LIS may be beamformed by jointly configuring these reflective surfaces to form one or more reflected beams. Each reflected beam may have specified physical properties, such as a specified beam direction, a specified beam width, and so on. Configuration of the LIS may be performed by a base station or any other suitable control device. For example, the base station or the control device may send an instruction to the LIS to adjust parameters (e.g., orientation, etc.) of one or more reflective surfaces of the LIS.

The inventor has realized that the characteristics of LIS make it useful for high-accuracy positioning of a UE. Specifically, one or more reflected beams reflected by the LIS may be used to locate the UE. This will be described further below.

### 2. LIS-ASSISTED HIGH-PRECISION POSITIONING

### 2.1 Exemplary Device

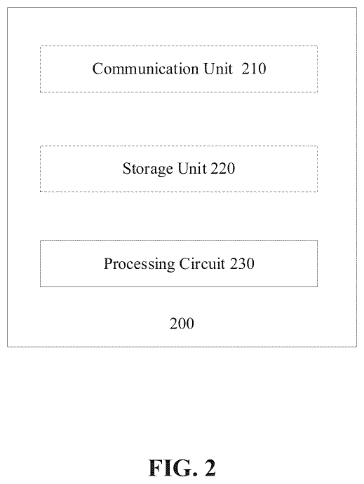

FIG. 2 illustrates an exemplary block diagram of an electronic device 200 according to an embodiment of the present disclosure. The electronic device 200 may be used to perform the LIS-assisted positioning method described in the present disclosure. Electronic device 200 may include a communication unit 210, a storage unit 220, and a processing circuit 230.

The communication unit 210 may be used to receive or send radio transmissions. The communication unit 210 may perform functions such as up-conversion, digital-to-analog conversion on a radio signal to be sent, and/or perform functions such as down-conversion, analog-to-digital conversion on a received radio signal. In an embodiment of the present disclosure, the communication unit 210 may be implemented using various technologies. For example, the communication unit 210 may be implemented as communication interface components, such as an antenna device, a radio frequency circuit, and a part of a baseband processing circuit. The communication unit 210 is drawn with dashed lines, as it may alternatively be located within the processing circuit 230 or external to the electronic device 200.

The storage unit 220 may store information generated by the processing circuit 230, information received from or sent to other devices through the communication unit 210, programs, machine codes, and data for operations of the electronic device 200, and the like. The storage unit 220 may be a volatile memory and/or a non-volatile memory. For example, the storage unit 220 may include, but is not limited to, a random access memory (RAM), a dynamic random access memory (DRAM), a static random access memory (SRAM), a read only memory (ROM), and a flash memory. The memory unit 220 is drawn with dashed lines, as it may alternatively be located within the processing circuit 230 or external to the electronic device 200.

The processing circuit 230 may be configured to perform one or more operations, thereby providing various functions of the electronic device 200. As an example, the processing circuit 230 may perform operations by executing one or more executable instructions stored in the storage unit 220.

According to an embodiment of the present disclosure, the electronic device 200 (and more specifically, the processing circuit 230) may be used to perform one or more operations described herein in relation to a base station 110. In this case, the electronic device 200 may be implemented as the base station 110 itself, a part of the base station 110, or a control device for controlling the base station 110. For example, the electronic device 200 may be implemented as a chip for controlling the base station 110.

When the electronic device 200 is used to implement the device on a base station side described in the present disclosure, the processing circuit 230 may be configured to perform one or more operations on the base station side described in the present disclosure. The one or more operations may comprise: causing a first set of LISs to reflect a set of first reflected beams to be used for a first beam scanning with a UE; causing a second set of LISs to reflect a set of second reflected beams to be used for a second beam scanning with the UE, wherein the second set of LISs is selected from the first set of LISs and a beam width for the set of second reflected beams is smaller than a beam width for the set of first reflected beams; and determining a position of the UE based at least in part on a result of the second beam scanning. Additionally, the processing circuit 230 may be configured to also perform one or more additional operations on the base station side described in the present disclosure.

According to an embodiment of the present disclosure, the electronic device 200 (and more specifically, the processing circuit 230) may be used to perform one or more operations described herein in relation to UE 120. In this case, the electronic device 200 may be implemented as the UE 120 itself, a part of the UE 120, or a control device for controlling the UE 120. For example, the electronic device 200 may be implemented as a chip for controlling the UE 120.

When the electronic device 200 is used to implement the device on the UE side described in the present disclosure, the processing circuit 230 may be configured to perform one or more operations on the UE side described in the present disclosure. The one or more operations may comprise: receiving a set of first reflected beams reflected from a first set of LISs to perform a first beam scanning; receiving a set of second reflected beams reflected from a second set of LISs to perform a second beam scanning, wherein the second set of LISs is selected from the first set of LISs, and a beam width for the set of second reflected beams is smaller than a beam width for the set of first reflected beams; and acquiring a position of the UE that is determined based at least in part on a result of the second beam scanning. Additionally, the processing circuit 230 may be configured to also perform one or more additional operations on the UE side described in the present disclosure.

It should be noted that the various units described above are exemplary and/or preferred modules for implementing the processes described in the present disclosure. These modules may be hardware units (such as central processing units, field programmable gate arrays, digital signal processors or application specific integrated circuits, etc.) and/or software modules (such as computer readable programs). The above content is not exhaustive description of modules used for implementing various steps described below. However, as long as there is a step for performing a certain process, there may be a corresponding module or unit (implemented by hardware and/or software) for implementing that process. Technical solutions defined by all combinations of steps described below and units corresponding to those steps are included in the content of the present disclosure, as long as the technical solutions they constitute are complete and applicable.

Furthermore, a device constituted by various units may be incorporated into a hardware device (such as a computer) as a functional module. In addition to those functional modules, the computer may of course have other hardware or software components.

### 2.2 Methods on the Base Station Side

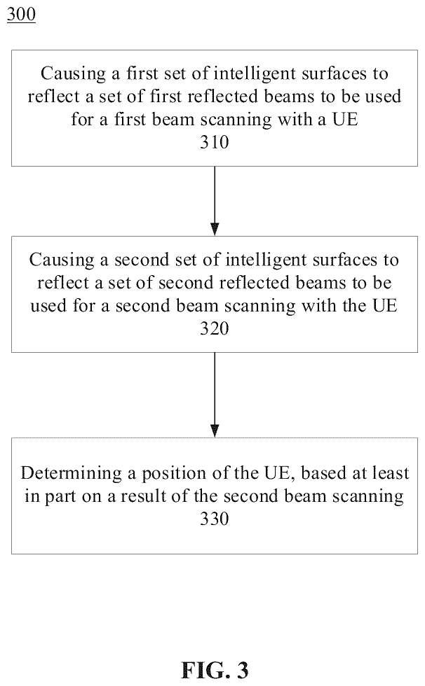

FIG. 3 illustrates an exemplary flowchart of a LIS-assisted positioning method 300 according to an embodiment of the present disclosure. The method 300 may be performed by an electronic device on the base station side. For example, when the electronic device 200 is used to implement the device on the base station side described in the present disclosure, the method 300 may be executed by the processing circuit 230 of the electronic device 200.

According to an embodiment of the present disclosure, the method 300 may be initiated in response to a positioning request from a UE to be located (e.g., UE 120). For example, the UE may send a message containing the positioning request to a base station. In response to receiving the message, the base station may initiate execution of the method 300. In other embodiments, the method 300 may be initiated based on other triggering conditions.

The method 300 may begin with step 310. In step 310, the base station (e.g., the base station 110) may cause a first set of LISs to reflect a set of first reflected beams. The reflected set of first reflected beams may be used for a first beam scanning with the UE to be located.

A plurality of LISs may be set up within the coverage area of each base station. These LISs may be placed in various suitable positions indoors and/or outdoors. A base station may be associated with those LISs. For example, the base station may collect LIS configuration information. The LIS configuration information may include LIS deployment within a cell, a reflective surface size, a coverage range, a coverage direction, a controllable angle, a LIS idle state, service capability of each LIS, etc.

The first set of LISs may include one or more LISs that are selected from multiple LISs associated with the base station. The first set of LISs may include one or more idle LISs. Idle LISs may include a LIS that is not currently serving for other purposes or, more generally, a LIS that currently has remaining capability that is available for UE positioning.

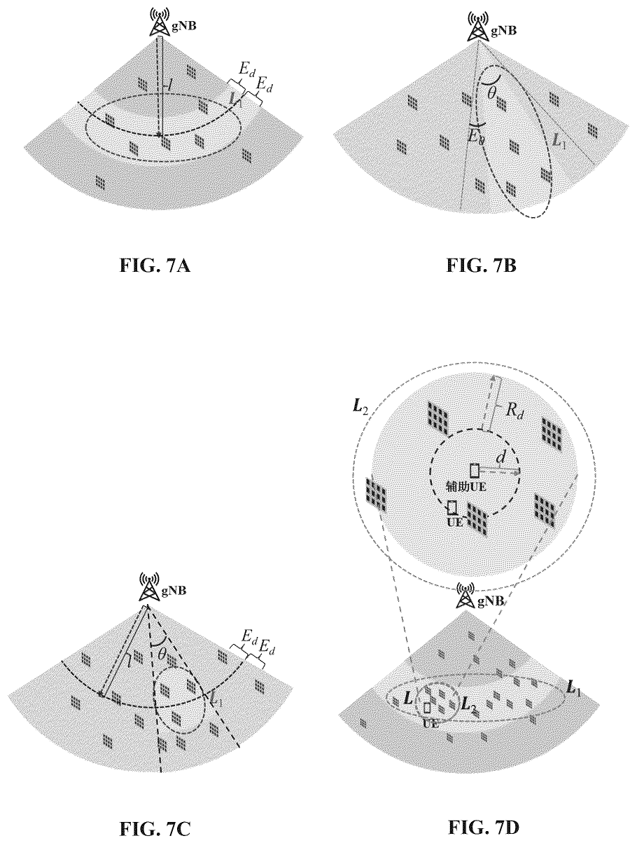

According to an embodiment of the present disclosure, the first set of LISs may be selected in various ways. In some embodiments, the first set of LISs may be selected based on information associated with the UE. For example, the first set of LISs may be selected based at least in part on initial position information of the UE. FIGS. 7A-7C illustrate example embodiments of selecting the first set of LISs based on the initial position information of the UE. Additionally, FIG. 7D further describes an example embodiment of selecting the first set of LISs based on a position of an assisting UE. However, it should be understood that the present disclosure is not limited to the embodiments shown in FIGS. 7A-7D. In an alternative embodiment, the first set of LISs may, by default, include all LISs associated with the base station. In yet other embodiments, the first set of LISs may be randomly selected.

According to an embodiment of the present disclosure, one or more reflective surfaces of each LIS in the first set of LISs may be configured such that a radio signal reflected by each LIS forms one or more reflected beams. The reflective surfaces may be configured such that the reflective surfaces perform desired beamforming of reflected signals of the incident radio signal, thereby generating one or more desired reflected beams. The radio signal reflected by the LIS may be referred to as a Positioning Reference Signal (PRS) in the present disclosure. The positioning reference signal may be designed to be suitable for beamforming and power measurements, etc.

According to an embodiment of the present disclosure, during the first beam scanning, for each LIS in the first set of LISs, a first positioning beam that has a maximum received power at the UE may be determined from the set of first reflected beams. Specifically, the UE may receive one or more reflected beams reflected from each LIS in the first set of LISs and measure the received power of each received reflected beam. The UE may receive, in a scanning order, one or more reflected beams reflected by each LIS in the first set of LISs. Then, for one or more reflected beams received from each LIS, the UE may determine, among the one or more reflected beams, a reflected beam with a maximum received power as a first positioning beam corresponding to the LIS. It may be considered that the reflected beam with the maximum received power is a reflected beam that is directed towards the UE (or has the highest degree of alignment with the UE) among multiple reflected beams of the LIS. First positioning beams corresponding to LISs in the first set of LISs may form a set of first positioning beams. The UE may report the set of first positioning beams to other devices (e.g., the base station or the assisting UE) as a result of the first beam scanning.

According to an embodiment of the present disclosure, a position range of the UE may be estimated based on the multiple first positioning beams. For example, an intersection area of the multiple first positioning beams in the set of first positioning beams may be used as a position range of the UE. Since the first positioning beams have larger beam widths, the estimated position range is rough. As discussed below, the position range may be an intermediate positioning result to be used in one or more subsequent steps. In addition, the position range may also be sent to the UE as the intermediate positioning result.

The method 300 may proceed to step 320. In step 320, the base station may cause a second set of LISs to reflect a set of second reflected beams. The reflected set of second reflected beams may be used for a second beam scanning with the UE. The second set of LISs may be selected from the first set of LISs. Also, the beam width for the set of second reflected beams may be smaller than the beam width for the set of first reflected beams.

According to an embodiment of the present disclosure, the second set of LISs may be selected from the first set of LISs based on the result of the first beam scanning. That is, the second set of LISs may be a subset of the first set of LISs. Such a selection may be performed based on one or more criteria.

In some embodiments, the one or more criteria may include a closest distance criterion, such that the second set of LISs includes a specified number of LISs in the first set of LISs that are closest to the UE.

Specifically, M LISs that are closest to the UE to be located may be selected from the first set of LISs to form the second set of LISs. M may be a predetermined positive integer. The position of each LIS may be a known fixed position (e.g., may be obtained from the LIS configuration information). The distance between the UE and each LIS may be estimated based on the position of each LIS and the rough position range of the UE determined from the first beam scanning. Then, one or more LISs closest to the UE may be selected based on the estimated distances. The second set of LISs may include the selected one or more LISs. In general, an LIS that is close to the UE may provide the UE with a reflected beam that has a high received power. Also, there may be fewer obstacles between the UE and that LIS. Therefore, selecting the second set of LISs based on the closest distance criterion may improve reliability and accuracy of measurements.

In an additional or alternative embodiment, the one or more criteria may include a strongest beam criterion, such that the second set of LISs includes a specified number of LISs in the first set of LISs that have first reflected beams with a maximum received power at the UE.

Specifically, M beams with a strongest received power may be selected from the set of first positioning beams, and M LISs corresponding to the M beams may be determined as the second set of LISs. In general, a reflected beam with a stronger power is able to resist a greater interference and thus enable a more accurate measurement. Therefore, selecting the second set of LISs based on the strongest beam criterion may improve reliability and accuracy of measurements.

In an additional or alternative embodiment, the one or more criteria may include idle state criteria, such that the second set of LISs include a specified number of LISs in the first set of LISs that are serving a minimum number of users.

Specifically, M LISs that are currently serving a smallest number of users may be selected from the first set of LISs to form the second set of LISs. In general, if a number of users currently served by an LIS is smaller, that LIS has a stronger capability to serve users and is less susceptible to interference from other users. Therefore, selecting the second set of LISs based on the idle state criterion may improve reliability and accuracy of measurements.

It should be noted that the above one or more criteria are only exemplary, and other criteria may be used to select the second set of LISs. One or more of those criteria may be used in combination without limitation. For example, multiple factors, such as the distance, the received power, and the idle state, may be weighted and the second set of LISs may be selected according to the weighted factors.

According to an embodiment of the present disclosure, a set of second reflected beams associated with the second set of LISs may be configured based on the result of the first beam scanning.

Specifically, a beam direction and a beam width for a second reflected beam corresponding to each LIS in the second set of LISs may be configured based on the beam direction and the beam width for the first positioning beam corresponding to that LIS. For example, each second reflected beam in the set of second reflected beams may be configured to have a beam direction that is substantially the same as that of a corresponding first positioning beam, and may be configured to have a smaller beam width than that of the corresponding first positioning beam. In the first beam scanning, the first positioning beam has a direction directed toward the UE. By configuring the second reflected beam to have the substantially same direction as the corresponding first positioning beam, the second reflected beam may also be substantially directed toward the UE, and thus it may be better received by the UE, that is, having a greater received power at the UE. Furthermore, by using the smaller beam width, the second reflected beam may cover only a portion of the area that is covered by the corresponding first positioning beam. Therefore, the smaller beam width for the second reflected beam allows determining a position range of the UE with higher accuracy.

According to an embodiment of the present disclosure, during the second beam scanning, for each LIS in the second set of LISs, a second positioning beam that has a maximum received power at the UE may be determined from the set of second reflected beams.

Specifically, the UE may receive one or more reflected beams reflected from each LIS in the second set of LISs and measure the received power of each received reflected beam. The UE may receive, in a scanning order, one or more reflected beams reflected by each LIS in the second set of LISs. Then, for the one or more reflected beams received from each LIS, the UE may determine, among the one or more reflected beams, a reflected beam with a maximum received power as a second positioning beam corresponding to that LIS. Second positioning beams corresponding to each LIS in the second set of LISs may form a set of second positioning beams. The set of second positioning beams may be reported to other devices (e.g., the base station or the assisting UE) as a result of the second beam scanning.

According to an embodiment of the present disclosure, in order to reduce interference, an interfering beam may be deactivated during the second beam scanning. The interfering beam may include one or more beams that are reflected by LISs that are different from the second set of LISs and are substantially directed towards the UE. Those interfering beams may potentially interfere with reception of the set of second reflected beams.

For each LIS in the first set of LISs that is not in the second set of LISs, a reflected beam travelling along the beam direction of the first positioning beam of that LIS may be determined as an interfering beam. Based on the first beam scanning, it may be known that each first positioning beam is substantially directed towards the UE. Therefore, an interfering beam with the same beam direction as the first positioning beam will also have a high received power at the UE, thereby causing potential interference to the reception of the set of second reflected beams. Such an interfering beam may be deactivated.

For an LIS that does not participate in the first beam scanning, a reflected beam of that LIS that is directed towards the rough position range of the UE may be determined as an interfering beam. As mentioned before, the rough position range of the UE may be determined as an intersection area of multiple first positioning beams. Similarly, an interfering beam directed towards the UE will have a high received power at the UE, causing potential interference to the reception of the set of second reflected beams. Such an interfering beam may be deactivated.

Deactivating the interfering beam may include configuring a respective LIS in such a way that the LIS will not reflect the interfering beam in a specific direction (i.e., the direction directed towards the UE). Additionally, or alternatively, deactivating the interfering beam may include causing the source not to transmit radio signals to the LIS that might result in generating the interfering beam. The LIS may reflect beams in other directions, without limitation.

The method 300 may proceed to step 330. In step 330, the base station may determine the position of the UE based at least in part on the result of the second beam scanning.

According to an embodiment of the present disclosure, the position of the UE may be determined based at least in part on one or more second positioning beams in the set of second positioning beams. Since the beam width for the second positioning beam is small, the position determined based on the second positioning beams has high accuracy.

In some embodiments, the position of the UE may be determined based on multiple second positioning beams in the set of second positioning beams. Specifically, the position of the UE may be determined as an intersection position of the multiple second positioning beams. In other embodiments, the position of the UE to be located may be determined based on at least one second positioning beam and a distance between the UE to be located and an assisting UE. Specifically, the position of the UE may be determined as an intersection position of (i) the at least one second positioning beam, and (ii) a circle centered on the assisting UE and with the distance as the radius. As described further below, an appropriate positioning scheme may be selected based on a selected positioning mode.

Additionally, the determined position of the UE may be sent to the UE. The UE may store and/or present the position for one or more other purposes.

The method 300 for positioning via reflected beams from the LISs has significant benefits.

For example, because an LIS has characteristics of low cost and low power consumption, the LIS may be widely deployed in various places. In comparison, costs of deploying Wi-Fi, base stations, and satellites are higher. Therefore, compared with the existing technologies, the method 300 may be applicable to more places. Compared with the base station positioning technology, the method 300 may not be limited by the position, the number, or the number of antennas of base stations.

Moreover, a large number of LISs provide a large number of potential communication paths for a positioning reference signal, so that reachability of the positioning reference signal is greatly improved. Moreover, the positioning reference signal received by the UE may have a high signal quality. In contrast, communication paths of positioning signals from Wi-Fi, base stations, and satellites are often restricted (i.e., more likely to be blocked). Therefore, compared with the existing technologies, applicability of the method 300 is greatly improved (especially in indoor positioning scenarios). Furthermore, improved signal quality may lead to improved positioning accuracy.

In addition, through a dual beam scanning process (the first beam scanning and the second beam scanning), the method 300 may significantly reduce positioning errors and improve positioning accuracy.

According to an embodiment of the present disclosure, the method 300 may include one or more additional steps. For example, different positioning modes may be selected for the UE to be located, thereby further adapting to different scenarios.

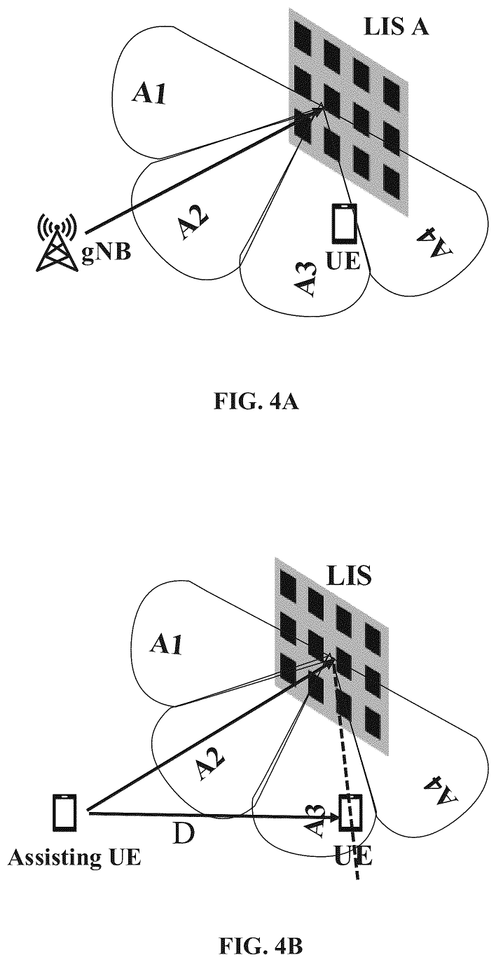

In different scenarios, different positioning modes may use different sources of positioning reference signals. FIGS. 4A-4B illustrate schematic diagrams of a first positioning mode and a second positioning mode according to embodiments of the present disclosure, respectively.

As shown in FIG. 4A, in the first positioning mode, the source of a positioning reference signal may be a base station. Accordingly, the set of first reflected beams and the set of second reflected beams may be formed based on positioning reference signals transmitted by the base station. The first positioning mode is a basic positioning mode that is suitable for almost all UEs. Compared with the second positioning mode, the first positioning mode is simpler and has higher applicability.

As shown in FIG. 4B, in the second positioning mode, the source of a positioning reference signal may be an assisting UE that is different from the UE to be located. The set of first reflected beams and the set of second reflected beams may be formed based on positioning reference signals transmitted by the assisting UE. The assisting UE may be another UE near the UE to be located, which may assist positioning of the UE to be located. Furthermore, a sidelink connection (indicated by the letter D) may exist between the assisting UE and the UE to be located. The assisting UE and the UE to be located may communicate directly through this sidelink connection.

Compared with the first positioning mode, the second positioning mode may have higher positioning accuracy. The second positioning mode combines advantages of the LIS and the assisting UE. The LIS may reflect fine beams, while the assisting UE may actively transmit positioning reference signals and has certain capabilities of calculation, control and measurement. The second positioning mode may make up for some defects of the first positioning mode. In the first positioning mode, the base station and the UE may be far away, which may result in poor channel quality and low measurement accuracy. In the second positioning mode, the distance between the UE to be located and the assisting UE is very close, so positioning reference signals received by the UE are strong and not easily blocked, which helps to improve accuracy and reliability of the measurement. Moreover, measurement of sidelink signals between the two UEs also helps to improve positioning accuracy. The second positioning mode reduces involvement of the base station, so it is possible to enable independent positioning in a scenario far away from any base station. Moreover, the second positioning mode may reuse time-frequency resources, so it will not affect normal cellular communication of the UE.

According to an embodiment of the present disclosure, the positioning mode for the UE to be located may be selected from the first positioning mode and the second positioning mode based on an attribute associated with the UE. The attribute associated with the UE to be located may include at least one of: capability of the UE to be located, a connection state of a sidelink of the UE, and quality of service for the UE. The UE to be located may report at least one of the capability of the UE, the connection state of the sidelink of the UE, and the quality of service for the UE to a base station when accessing to the base station, so that the base station may select an appropriate positioning mode for the UE based on the received information.

In one example, if the capability of the UE to be located does not support the sidelink, the first positioning mode may be selected. Additionally or alternatively, if the UE to be located has established a sidelink connection with another UE, the second positioning mode may be selected. Additionally or alternatively, if the serving quality by the base station for the UE to be located is good enough, the first positioning mode may be selected. Each of these factors may be considered individually or in combination.

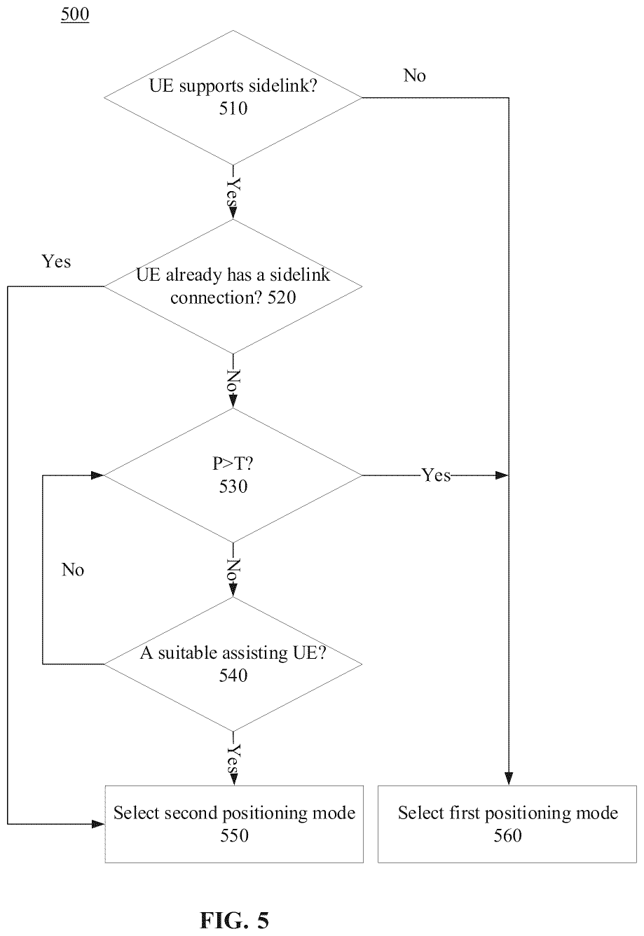

FIG. 5 illustrates an exemplary flowchart of a method 500 for selecting a positioning mode for a UE according to an embodiment of the present disclosure.

In step 510, it may be determined whether capability of the UE to be located supports a sidelink. If the capability of the UE to be located does not support the sidelink, the method 500 may proceed to step 560, wherein the first positioning mode is selected as the positioning mode for the UE. Otherwise, the method 500 may proceed to step 520.

In step 520, it may be determined whether the UE already has a sidelink connection. If the UE already has a sidelink connection with another UE, the method 500 may proceed to step 550, in which the second positioning mode is selected as the positioning mode for the UE. In this case, the other UE may additionally be selected as an assisting UE. If the UE to be located does not yet have a sidelink connection, the method 500 may proceed to step 530.

In step 530, it may be determined whether the quality of service for the UE is higher than a threshold value. P is used to represent a received power level of the UE for a signal from the base station, and T is used to represent a predetermined threshold value. If P>T, the signal from the base station may be well received by the UE, so the method 500 may proceed to step 560, in which the first positioning mode is selected as the positioning mode for the UE. Otherwise, the method 500 may proceed to step 540.

In step 540, it may be determined whether there is a suitable assisting UE. The assisting UE may need to meet one or more requirements. For example, the assisting UE needs to be located near the UE to be located and/or the assisting UE needs to be able to support a sidelink. For discovery and selection of a suitable assisting UE, any existing sidelink discovery process may be used. Additionally or alternatively, based on a rough position range of the UE determined by the first beam scanning, one or more other UEs that are proximate to the rough position range of the UE and support sidelinks may be searched. A channel quality or a distance between each of the one or more other UEs and the UE to be located may be measured. If the measured channel quality is higher than a preset quality threshold and/or the measured distance is smaller than a preset distance threshold, that other UE may be determined as a suitable assisting UE. If all of the one or more other UEs do not satisfy the preset quality threshold and the preset distance threshold, it may be determined that there is no suitable assisting UE. If there is a suitable assisting UE, the method 500 may proceed to step 550, in which the second positioning mode is selected as the positioning mode for the UE. Otherwise, the method 500 may return to step 540.

By taking a number of factors into consideration to select the positioning mode for the UE, a positioning mode that is most suitable for both the UE to be located and the current scenario may be selected. Therefore, the method of the present disclosure may be suitable to users with various capabilities and in various environments.

According to an embodiment of the present disclosure, in response to selecting the positioning mode for the UE, the UE to be located and/or the assisting UE may be notified of the selected positioning mode.

According to an embodiment of the present disclosure, depending on the selected positioning mode, the base station further transmits one or more pieces of configuration information or scheduling information to the UE to be located and/or to the assisting UE.

In response to a selection of the first positioning mode, the base station may transmit positioning signaling to the UE to be located. The positioning signaling may include scanning configuration information. For the first beam scanning and the second beam scanning, the base station may transmit respective scanning configuration information respectively. The scanning configuration information may be used to indicate information associated with a respective beam scanning to the UE. For example, the scanning configuration information may include identification information of each LIS that will be used for positioning the UE, such as an identifier of each LIS. As such, the scanning configuration information may notify the UE of the selected first set of LISs or the second set of LISs. Additionally, the scanning configuration information may also include identification information of one or more reflected beams associated with each LIS, for example, an identifier of each reflected beam. Additionally, the scanning configuration information may also include a scanning order, such as a scanning order of multiple LISs and/or a scanning order of multiple reflected beams of each LIS.

The base station and the UE may complete the first beam scanning and/or the second beam scanning based on the scanning configuration information. For example, the base station may send corresponding positioning reference signals to each LIS in accordance with the scanning order specified by the scanning configuration information. Furthermore, the base station may also configure each LIS to form multiple reflected beams in a specified scanning order. Accordingly, the UE may receive the multiple reflected beams of each LIS in the multiple LISs in accordance with the scanning order specified by the scanning configuration information. When reporting results of the first beam scanning and/or the second beam scanning, the UE may use the identification information of the LISs and the identification information of the reflected beams to identify the set of first positioning beams and/or the set of second positioning beams as well as associated LISs.

In response to a selection of the second positioning mode, the base station may transmit scanning scheduling information to the assisting UE. Based on the scanning scheduling information, the assisting UE may be configured to schedule different time-frequency resources to transmit positioning reference signals for different LISs, thereby forming different reflected beams that the UE is able to distinguish. Unlike the base station, the assisting UE generally does not have pre-beamforming capability. Therefore, positioning reference signals transmitted by the assisting UE are not directed towards a certain LIS, but transmitted in multiple directions. In this case, each positioning reference signal transmitted by the assisting UE may be reflected by multiple LISs. The scanning scheduling information may schedule positioning reference signals for different LIS on different time-frequency resources (for example, in different time slots), so that the UE to be located is able to identify corresponding reflected beams.

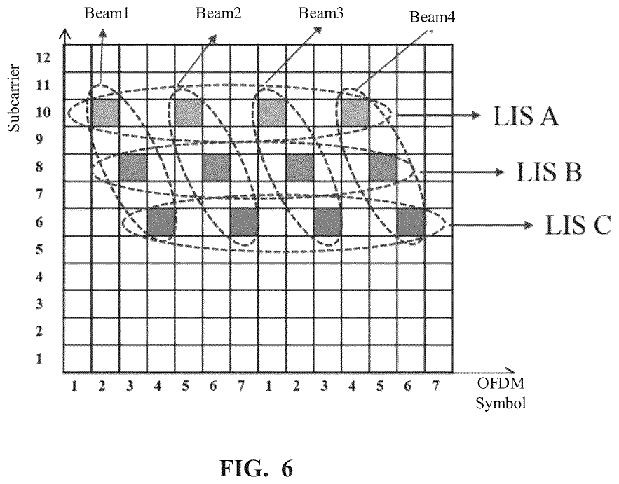

FIG. 6 illustrates an exemplary time-frequency resource scheduling of reflected beams according to an embodiment of the present disclosure. As shown, each of LIS A, LIS B, and LIS C may have associated four reflected beams (1, 2, 3, 4). Reflected beams of different LIS of LIS A, LIS B and LIS C may be scheduled on different subcarriers. Furthermore, each of multiple reflected beams associated with each LIS may be associated with a different OFDM symbol. In this way, the UE to be located may identify reflected beams from different LISs based on subcarriers and/or OFDM symbols. It should be understood that the time-frequency resource scheduling shown in FIG. 6 is only exemplary and not restrictive. In other embodiments, other time-frequency resource scheduling may be used.

Additionally, identification information of each LIS and/or identification information of each reflected beam may be carried on the transmitted positioning reference signal. The UE to be located may extract, from the received reflected beam, respective identification information of the LIS and/or identification information of the reflected beam. In this way, the base station no longer needs to transmit the identification information of each LIS, the identification information of each reflected beam, and/or the scanning order to the UE to be located through an individual positioning signaling.

According to an embodiment of the present disclosure, in the first positioning mode, configuring of each LIS may be performed by the base station. In the second positioning mode, configuring of each LIS may be performed by the base station, or alternatively by the assisting UE. In some embodiments, the base station may retain control of the LIS. Accordingly, during the first beam scanning and the second beam scanning, each LIS in the first set of LISs and the second set of LISs may be configured by the base station to generate a specified reflected beam. In other embodiments, the base station may temporarily transfer control of an LIS to the assisting UE. Accordingly, during the first beam scanning and the second beam scanning, each LIS in the first set of LISs and the second set of LISs may be configured by the assisting UE to generate a specified reflected beam. The control of the assisting UE to the LIS may be terminated after the positioning process ends.

### 2.3 Exemplary Embodiments

FIGS. 7A-7C describe example embodiments of selecting a first set of LISs based on initial position information of a UE. The initial position information of the UE may include one or more of a distance between the UE and a base station, a direction of the UE with respect to the base station, or an initial geographical location of the UE. A candidate area may be determined based on the initial position information of the UE, and one or more LISs in the candidate area may be determined as the first set of LISs.

In the embodiment of FIG. 7A, the initial position information of the UE may include the distance l between the UE and the base station. The candidate area may be selected based on this distance l. As shown, the candidate area may be determined as an annular area surrounding the base station. The central ring of the annular area is distanced from the base station by the distance l, and the radial width of the annular area is 2E_{d}. One or more LISs in this sector area may be determined as the first set of LISs, L₁. E_{d} is a preset error value which is used to describe an error associated with distance l. In one example, the preset error value E_{d} may be a fixed value. Alternatively, E_{d} may be a function of distance l (e.g., the smaller l, the smaller E_{d}).

The distance l between the UE and the base station may be determined in various ways.

In some embodiments, the distance l between the UE and the base station may be estimated according to a cell reference signal received power (CRS-RSRP) of the UE. Specifically, the CRS-RSRP of the UE and a corresponding base station transmission power may be obtained, and the distance l between the UE and the base station is estimated based on a path loss model.

In other embodiments, the distance l may be estimated according to the time for a signal to arrive at the UE from the base station. Specifically, the base station may transmit a measurement reference signal to the UE, and the UE may measure and report the arrival time of the measurement reference signal. The distance l may be calculated based on the transmission time and the arrival time of the measurement reference signal. As an example, the measurement reference signal used may be a positioning reference signal (PRS). Compared with the implementation where CRS-RSRP is used, the implementation using the measurement reference signal requires extra measurements, but may obtain a more accurate distance l.

In the embodiment of FIG. 7B, the initial position information of the UE may include a direction θ of the UE with respect to the base station. The UE accesses to the base station via access beam(s). Therefore, the direction θ of the UE with respect to the base station may be estimated by the direction of the access beam. The candidate area may be selected based on this direction θ. As shown, the candidate area may be determined as a sector area starting from the base station, which points in the direction θ and has an angular width of 2E_{θ}. One or more LISs in the sector area may be determined as the first set of LISs, L₁. E_{θ} is a preset error value describing the error associated with the direction θ. In one example, the preset error value E_{θ} may be a fixed value. Alternatively, E_{θ} may be a function of direction θ.

In the embodiment of FIG. 7C, the initial position information of the UE may include both the distance l between the UE and the base station and the direction θ of the UE with respect to the base station. In this case, the candidate area may be determined as an overlapping area between the annular area of FIG. 7A and the sector area of FIG. 7B. One or more LISs in the overlapping area may be determined as the first set of LISs, L₁.

In addition, the initial position information of the UE may also include an initial geographical location of the UE. The initial geographic location may be imprecise, such as a rough range determined by existing positioning technology. In this case, the candidate area may be determined as an area near the initial geographical location, and one or more LISs in the candidate area may be determined as the first set of LISs, L₁.

According to an embodiment of the present disclosure, in response to a selection of the second positioning mode, the first set of LISs for the first beam scanning may be determined further based on a position of an assisting UE. For example, the first set of LISs may be defined as one or more LISs in the vicinity of the assisting UE. In this way, it can be ensured that a positioning reference signal transmitted by the assisting UE may be effectively reflected by the first set of LISs. FIG. 7D describes an example embodiment of determining the first set of LISs based on the position of the assisting UE.

As shown in the enlarged portion of FIG. 7D, an annular area surrounding the assisting UE may be determined. The inner ring of the annular area is distanced from the position of the assisting UE by a distance d, and the radial width of the annular area is R_{d}. The position of the assisting UE may be a predetermined known position. d may represent the distance between the assisting UE and the UE to be located. d may be estimated based on sidelink signals between the assisting UE and the UE to be located. For example, d may be estimated based on the reference signal received power of a sidelink signal. Additionally or alternatively, d may be calculated based on the transmission-arrival time of the sidelink signal between the UE to be located and the assisting UE. R_{d} may be a prespecified error value, which may be a fixed value or a function of d.

An overlapping area between the candidate area determined previously with respect to FIGS. 7A-7C and the determined annular area surrounding the assisting UE may be determined as a reduced candidate area. One or more LISs in the reduced candidate area may be determined as the first set of LISs. In this way, it may be ensured that each LIS in the first set of LISs may be located near both the UE to be located and the assisting UE, so that the positioning reference signal transmitted by the assisting UE may be effectively reflected by the first set of LISs and the resulting reflected beam may be received by the UE to be located.

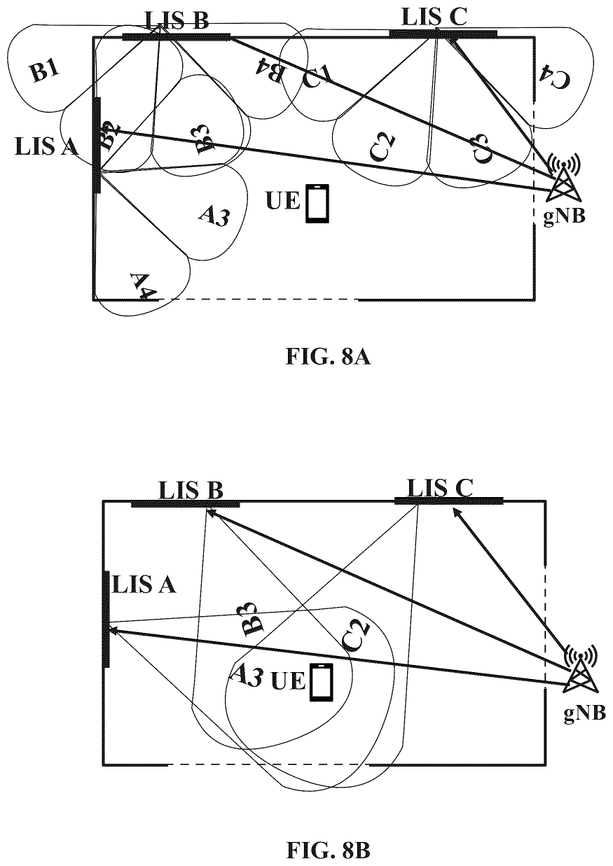

FIGS. 8A-8B illustrate schematic diagrams of a first beam scanning according to embodiments of the present disclosure.

In the embodiment of FIG. 8A, the first set of LISs, L₁, may include LIS A, LIS B, and LIS C. In response to a positioning reference signal transmitted by the base station, reflected positioning reference signals of LIS A may form four reflected beams A1-A4, each of which may have a respective direction. Similarly, reflected positioning reference signals of LIS B may form four reflected beams B1-B4, each of which may have a respective direction. Reflected positioning reference signals of LIS C may form four reflected beams C1-C4, each of which may have a respective direction.

In the first beam scanning, each reflected beam may have a relatively large beam width. For example, as shown in FIG. 8A, each reflected beam may have a beam width covering a range of approximately 45°. It should be understood that this beam width is exemplary and not restrictive.

Some or all of the reflected beams formed by LIS A, LIS B, and LIS C may be received by the UE. The UE may measure the power of the received reflected beams and determine a reflected beam associated with each LIS that has a strongest received power. It may be considered that the reflected beam with the strongest received power is a beam directed towards the UE among multiple reflected beams reflected by the LIS. This reflected beam may be used as a first positioning beam corresponding to that LIS.

As shown in FIG. 8B, for LIS A, the UE may measure the power of the received reflected beams A1-A4. It may be determined that reflected beam A3 has the strongest received power. Therefore, reflected beam A3 may be determined as the first positioning beam corresponding to LIS A. Similarly, reflected beam B3 may be determined as the first positioning beam corresponding to LIS B, and reflected beam C2 may be determined as the first positioning beam corresponding to LIS C. The reflected beams A3, B3, and C2 may form a set of first positioning beams corresponding to the first set of LISs, L₁. In some implementations, the UE may determine and report the set of first positioning beams to another device (e.g., a base station or an assisting UE). In other embodiments, the UE may report the measured received power of each reflected beam to another other device, which may determine the set of first positioning beams based on the received power of each reflected beam. It should be understood that the individual first positioning beams shown in the figure is exemplary and not restrictive.

It should be understood that, although FIGS. 8A-8B illustrate that the source of the positioning reference signals reflected by each LIS is the base station, the source of the positioning reference signals reflected by the LISs may alternatively be another device (for example, an assisting UE) in another positioning mode.

It should be understood that, the first set of LISs, L₁, is only exemplary. In other embodiments, the first set of LISs L₁ may include a smaller number of LISs (e.g., only include LIS A and LIS C). In still other embodiments, the first set of LISs L₁ may include a larger number of LISs, such as 4, 6, 9 or any other number of LISs, etc.

It should be understood that, the number, the beam width and the beam direction of reflected beams by each LIS in the first set of LISs L₁ are only exemplary. In other embodiments, the number, the beam width, and the beam direction of reflected beams by each LIS may differ from the embodiment of FIG. 8A. For example, each LIS may form 2, 3, 5 or even more reflected beams. Also, different LISs may form different numbers of reflected beams. The reflected beams may have a same beam width or different beam widths. The number of reflected beams, the beam width, and/or the beam direction of each reflected beam formed by the LIS may be controlled through configuring one or more reflective surfaces of each LIS in the first set of LISs L₁.

FIGS. 8C-8D illustrate schematic diagrams of a second beam scanning according to embodiments of the present disclosure. The embodiments of FIGS. 8C-8D may be continuations of the embodiments of FIGS. 8A-8B.

As shown in FIG. 8C, the determined second set of LISs L₂ may include LIS A, LIS B, and LIS C. The second set of LISs L₂ may be determined based on one or more criteria described previously. It should be understood that the second set of LISs L₂ is only exemplary and happens to be identical to the first set of LISs L₁. In other embodiments, the second set of LISs L₂ may include only a portion of LISs in the first set of LISs L₁ (e.g., LIS A and LIS B) and exclude the other LIS (e.g., LIS C).

Each LIS in the second set of LISs L₂ may be configured such that the LIS reflects the positioning reference signal from the source, thereby forming the set of second reflected beams.

As an example, the set of second reflected beams associated with LIS C may include three reflected beams C2-1, C2-2, C2-3. Reflected beams C2-1, C2-2, C2-3 together generally cover the direction of the first positioning beam C2 associated with LIS C, but each has a smaller beam width than the first positioning beam C2. For example, thee width of the reflected beams C2-1, C2-2, C2-3 associated with LIS C may be one-third f the width of the first positioning beam C2 associated with LIS C. In the first beam scanning, each reflected beam may have a beam width covering a range of approximately 45°. Accordingly, in the second beam scanning, each reflected beam may have a beam width covering a range of approximately 15°. In other words, the second beam scanning may be a narrow beam scanning if compared to the first beam scanning.

Similarly, the set of second reflected beams associated with LIS A may include three reflected beams A3-1, A3-2, A3-3 (not labeled). Reflected beams A3-1, A3-2, A3-3 together generally cover the direction of the first positioning beam A3 associated with LIS A, but each has a smaller beam width than a beam width for the first positioning beam A3. The set of second reflected beams associated with LIS B may include three reflected beams B3-1, B3-2, B3-3 (not labeled). Reflected beams B3-1, B3-2, B3-3 together generally cover the direction of the first positioning beam B3 associated with LIS B, but each has a smaller beam width than a beam width for the first positioning beam B3.

It should be understood that the number and the direction of the reflected beams by each LIS are exemplary only. In other embodiments, the number and the direction of reflected beams by each LIS may differ from the embodiment of FIG. 8C. For example, each LIS may form 2, 4, 5 or even more reflected beams. Also, different LISs may form different numbers of reflected beams. The number of reflected beams, the beam width for reflected beams, and/or the beam direction of each reflected beam formed by each LIS may be controlled through configuring one or more reflective surfaces of the LIS in the second set of LISs L₂.

Reflected beams formed by LIS A, LIS B, and LIS C may be received by the UE. For LIS A, the UE may measure strengths of the received reflected beams A3-1, A3-2, and A3-3. It may be determined that reflected beam A3-2 has a strongest received power. Therefore, reflected beam A3-2 may be determined as the second positioning beam corresponding to LIS A. Similarly, reflected beam B3-2 may be determined as the second positioning beam corresponding to LIS B. Reflected beam C2-1 may be determined as the second positioning beam corresponding to LIS C. The reflected beams A3-2, B3-2, and C2-1 may form the set of second positioning beams corresponding to the second set of LISs L₂. In some embodiments, the UE may determine and report the set of second positioning beams to another device (e.g., a base station or an assisting UE). In other embodiments, the UE may report the measured received power of each reflected beam to another device, which may determine the set of second positioning beams based on the received power of each reflected beam. It should be understood that each second positioning beam shown in the figure is exemplary and not restrictive.

Then, the position of the UE may be determined based on one or more of the second positioning beams A3-2, B3-2, C2-1.

According to an embodiment of the present disclosure, different positioning schemes may be used based on different positioning modes. In the first positioning mode (where the LIS reflects the positioning reference signal from the base station), the position of the UE may be determined based on multiple second positioning beams in the set of second positioning beams. The position of the UE may be determined as an intersection position of the multiple second positioning beams. Since the second positioning beams have a relatively small beam width, the intersection point of the multiple second positioning beams may be a precise position with low error.

For example, in the embodiment of FIG. 8D, the position of the UE may be determined as the intersection position of the second positioning beams A3-2, B3-2, and C2-1. The intersection area of the second positioning beams A3-2, B3-2, and C2-1 will be significantly smaller than the intersection area of the first positioning beams A3, B3, and C2. Therefore, the position range of the UE determined based on the second positioning beams A3-2, B3-2, and C2-1 will be more accurate than the position range of the UE determined based on the first positioning beams A3, B3, and C2.

The number of second positioning beams participating in positioning may be selected based on positioning accuracy requirements. Generally, a higher positioning accuracy requirement leads to a larger number of second positioning beams that are selected to participate in positioning.

In the second positioning mode, if there are multiple second positioning beams, the position of the UE may also be determined as the intersection position of the multiple second positioning beams. Alternatively, the position of the UE to be located may be determined based on the distance between the UE to be located and the assisting UE and at least one second positioning beam. The at least one second positioning beam is determined for at least one LIS in the second set of LISs during the second beam scanning.

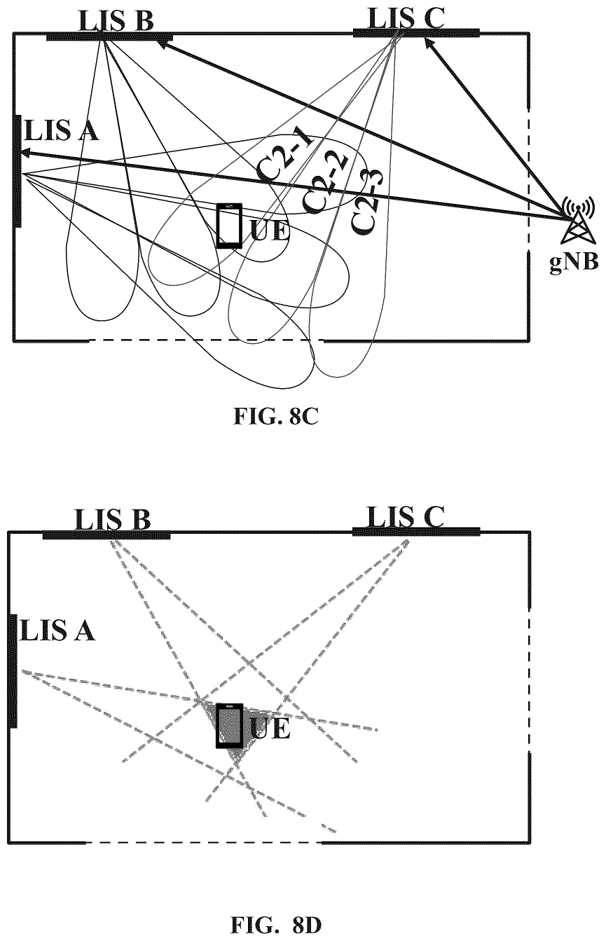

FIG. 9 illustrates a schematic diagram of determining the position of the UE to be located based on the distance between the UE and the assisting UE according to an embodiment of the present disclosure. As shown, a circle with the assisting UE as the center and the distance d between the UE to be located and the assisting UE as the radius may be determined. Then, the position of the UE to be located may be determined as the intersection position of the circle and the at least one second positioning beam (e.g., the second positioning beam associated with LIS A).

If there is only one intersection position of the second positioning beam used and the circle, that intersection position may be determined as the position of the UE. If there are two intersection positions of the second positioning beam used and the circle, one of the intersection positions matching the received power may be selected, based on the received power (e.g., RSRP) of the UE for the second positioning beam, as the determined position of the UE. For example, if the received power is large enough (e.g., greater than a specified threshold), the intersection position closer to the LIS among the two intersection positions may be selected. If the received power is not large enough (for example, not greater than a specified threshold), the intersection position farther from the LIS among the two intersection positions may be selected. In this embodiment, a minimum of one second positioning beam may be used in the second positioning mode for positioning, thereby reducing the number of required LISs.

According to an embodiment of the present disclosure, the distance d between the UE to be located and the assisting UE may be determined based on a sidelink signal between the assisting UE and the UE to be located. Specifically, a positioning signal may be communicated between the assisting UE and the UE to be located through a sidelink between the two UEs, and a precise distance between the UE to be located and the assisting UE may be calculated based on the transmission time and the arrival time of the positioning signal (for example, based on a difference between the transmission time and the reception time). Preferably, the positioning signal may be transmitted by the assisting UE to the UE to be located. Alternatively, the UE to be located may transmit the positioning signal to the assisting UE. As an example, the positioning signal may be a positioning reference signal that is specifically designed for the sidelink. It should be understood that the distance between the UE to be located and the assisting UE may also be determined by other various ways.

### 2.4 Method on the UE Side

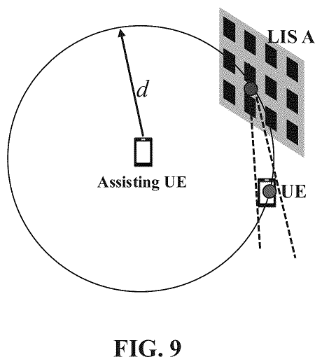

FIG. 10 illustrates an exemplary flowchart of a LIS-assisted positioning method 1000 according to an embodiment of the present disclosure. The method 1000 may be performed by an electronic device on a UE side. For example, when the electronic device 200 is used to implement the device on the UE side described in the present disclosure, the method 1000 may be performed by the processing circuit 230 of the electronic device 200.

The method 1000 may begin with step 1010. In step 1010, a UE to be located (e.g., UE 120) may receive a set of first reflected beams that are reflected from a first set of LISs to perform a first beam scanning.

The method 1000 may proceed to step 1020. In step 1020, the UE may receive a set of second reflected beams reflected from a second set of LISs to perform a second beam scanning. The second set of LISs may be selected from the first set of LISs. Also, a beam width for the set of second reflected beams may be smaller than a beam width for the set of first reflected beams.

The method 1000 may proceed to step 1030. In step 1030, the UE may obtain a position of the UE. The position of the UE may be determined based at least in part on a result of the second beam scanning.

According to an embodiment of the present disclosure, the first set of LISs may be associated with an initial position of the UE. As has been discussed previously, the first set of LISs may be determined based on the initial position information of the UE. In addition, in the second positioning mode, the first set of LISs may also be associated with a position of an assisting UE. Specifically, the first set of LISs may be reduced further based on the position of the assisting UE. The UE may receive information associated with the determined first set of LISs and the set of first reflected beams, for example, scanning configuration information from the base station for the first beam scanning.

According to an embodiment of the present disclosure, the first beam scanning may include: for each LIS in the first set of LISs, determining, from the set of first reflected beams, a first positioning beam that has a maximum received power at the UE. As has been discussed previously, the UE may further report the determined set of first positioning beams.

According to an embodiment of the present disclosure, at least one of the second set of LISs and the set of second reflected beams is determined based at least in part on a result of the first beam scanning. As has been discussed previously, the second set of LISs may be selected from the first set of LISs based on one or more criteria, and the set of second reflected beams may be configured in association with the second set of LISs. The UE may receive information associated with the second set of LISs and the set of second reflected beams, for example, scanning configuration information from the base station for the second beam scanning.

According to an embodiment of the present disclosure, the second beam scanning may include: for each LIS in the second set of LISs, determining, from the set of second reflected beams, a second positioning beam that has a maximum received power at the UE. As has been discussed previously, the UE may further report the determined set of second positioning beams.

According to an embodiment of the present disclosure, the position of the UE may be determined based at least in part on the second positioning beam(s).

According to an embodiment of the present disclosure, the UE may receive a positioning mode that is selected for the UE, and the selected positioning mode includes one of a first positioning mode and a second positioning mode. In the first positioning mode, the set of first reflected beams and the set of second reflected beams are formed based on a radio signal transmitted by the base station. In the second positioning mode, the set of first reflected beams and the set of second reflected beams are formed based on a radio signal transmitted by an assisting UE that is different from the UE.

According to an embodiment of the present disclosure, the UE may report to the base station at least one of: capability of the UE, a connection state of a sidelink of the UE, and quality of service for the UE. The reported parameters may be used to select the positioning mode for the UE.

According to an embodiment of the present disclosure, in response to determining that the first positioning mode is selected, the UE may receive scanning configuration information. The scanning configuration information may include identification information of each LIS that will be used for positioning the UE, identification information of one or more reflected beams associated with each LIS, and a scanning order.

According to an embodiment of the present disclosure, in response to determining that the first positioning mode is selected, the UE may determine multiple second positioning beams for multiple LISs in the second set of LISs. Furthermore, the position of the UE may be determined based on the multiple second positioning beams. Specifically, the position of the UE may be determined as an intersection position of the multiple second positioning beams.

According to an embodiment of the present disclosure, in response to determining that the second positioning mode is selected, the UE may determine at least one second positioning beam for at least one LISs in the second set of LISs. Furthermore, the position of the UE may be determined based on the at least one second positioning beam and a distance between the UE and the assisting UE. As has been discussed previously, the position of the UE may be determined as an intersection position of the at least one second positioning beam and a circle surrounding the assisting UE.

According to an embodiment of the present disclosure, the distance between the UE to be located and the assisting UE may be determined based on a sidelink signal between the UE and the assisting UE.

It should be understood that method 1000 is exemplary only. Those skilled in the art may understand that the method on the UE side may not only include the steps that have been described with respect to the method 1000, but may also include one or more of the steps of previously described methods.

### 3. APPLICATION EXAMPLES

The technology of the present disclosure can be applied to various products.

For example, a control-side electronic device according to an embodiment of the present disclosure may be implemented as or included in various control devices/base stations. For example, a transmitting device and a terminal device according to an embodiment of the present disclosure may be implemented as or included in various terminal devices.

For example, the control device/base station mentioned in the present disclosure may be implemented as any type of base station, for example eNB, such as macro eNB and small eNB. A small eNB may be an eNB that covers a cell smaller than a macro cell, such as a pico eNB, a micro eNB, and a home (femto) eNB. For another example, it may be implemented as a gNB, such as a macro gNB and a small gNB. A small gNB may be a gNB covering a cell smaller than a macro cell, such as a pico gNB, a micro gNB, and a home (femto) gNB. Alternatively, the base station may be implemented as any other type of base station, such as NodeB and Base Transceiver Station (BTS). The base station may include: a main body (also referred to as a base station device) configured to control radio communication; and one or more Remote Radio Heads (RRHs) disposed at a different location from the main body. In addition, various types of terminals to be described below may each operate as a base station by performing base station functions temporarily or semi-persistently.

For example, the terminal devices mentioned in the present disclosure may be implemented as mobile terminals (such as smart phones, tablet personal computers (PCs), notebook PCs, portable game terminals, portable/dongle-type mobile routers and digital cameras) or vehicle-mounted terminals (such as vehicle navigation devices) in some embodiments. The terminal device may also be implemented as a terminal performing machine-to-machine (M2M) communication (also referred to as a machine type communication (MTC) terminal). In addition, the terminal device may be a radio communication module (such as an integrated circuit module including a single wafer) mounted on each of the above terminals.

Application examples according to the present disclosure will be described below with reference to the drawings.

### [Examples for Base Stations]

It should be understood that the term base station in the present disclosure has the full breadth of its ordinary meaning, and includes at least a radio communication station used as portion of a wireless communication system or radio system to facilitate communication. Examples of the base station may be, for example but not limited to, the following: the base station may be either or both of a base transceiver station (BTS) and a base station controller (BSC) in the GSM system, and may be either or both of a radio network controller (RNC) or Node B in the WCDMA system, may be eNB in the LTE and LTE-Advanced system, or may be corresponding network nodes in future communication systems (e.g., the gNB that may appear in the 5G communication systems, eLTE eNB, etc.). Some of the functions in the base station of the present disclosure may also be implemented as an entity having a control function for communication in the scenario of a D2D, M2M, V2V and V2X communication, or as an entity that plays a spectrum coordination role in the scenario of a cognitive radio communication.

### First Example

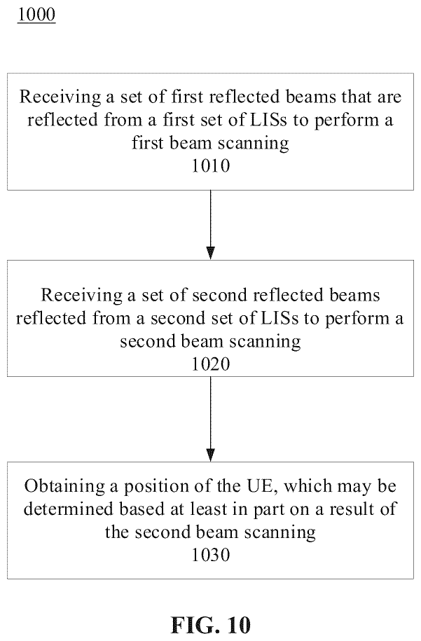

FIG. 11 is a block diagram showing a first example of a schematic configuration of a gNB to which the technology of the present disclosure may be applied. The gNB 2100 includes multiple antennas 2110 and a base station device 2120. The base station device 2120 and each antenna 2110 may be connected to each other via an RF cable. In one implementation, the gNB 2100 (or the base station device 2120) here may correspond to the above electronic device on the control side.

Each of the antennas 2110 includes a single or multiple antenna elements (such as multiple antenna elements included in a Multiple Input Multiple Output (MIMO) antenna), and is used for the base station device 2120 to send and receive wireless signals. As shown in FIG. 11, gNB 2100 may include multiple antennas 2110. For example, multiple antennas 2110 may be compatible with multiple frequency bands used by gNB 2100.

The base station device 2120 includes a controller 2121, a memory 2122, a network interface 2117 and a wireless communication interface 2125.

The controller 2121 may be, for example, a CPU or a DSP, and operates various functions of a higher layers of the base station device 2120. For example, the controller 2121 determines location information of a target terminal device in the at least one terminal devices according to the positioning information of at least one terminal device on the terminal side in the wireless communication system and a specific location configuration information of the at least one terminal device acquired by the wireless communication interface 2125. The controller 2121 may have a logical function to perform control such as radio resource control, radio bearer control, mobility management, access control and scheduling. This control may be performed in conjunction with nearby gNBs or core network nodes. The memory 2122 includes RAM and ROM, and stores programs executed by the controller 2121 and various types of control data (such as a terminal list, transmission power data, and scheduling data).

The network interface 2123 is a communication interface for connecting the base station device 2120 to the core network 2124. The controller 2121 may communicate with the core network node or another gNB via the network interface 2117. In this case, the gNB 2100 and the core network node or other gNB may be connected to each other through logical interfaces such as S1 interface and X2 interface. The network interface 2123 may also be a wired communication interface or a wireless communication interface for wireless backhaul. If the network interface 2123 is a wireless communication interface, the network interface 2123 may use a higher frequency band for wireless communication than the frequency band used by the wireless communication interface 2125.

The wireless communication interface 2125 supports any cellular communication scheme such as Long Term Evolution (LTE) and LTE-Advanced, and provides a wireless connection to terminals located in a cell of the gNB 2100 via the antenna 2110. The wireless communication interface 2125 may generally include, for example, a baseband (BB) processor 2126 and an RF circuit 2127. The BB processor 2126 may perform, for example, encoding/decoding, modulation/demodulation, and multiplexing/demultiplexing, and perform various types of signal processing for layers (such as L₁, Medium Access Control (MAC), Radio Link Control (RLC), and Packet Data Convergence Protocol (PDCP)). Instead of the controller 2121, the BB processor 2126 may have a part or all of the logic functions described above. The BB processor 2126 may be a memory storing a communication control program, or a module including a processor configured to execute a program and related circuits. The update program may cause the function of the BB processor 2126 to change. The module may be a card or a blade inserted into a slot of the base station device 2120. Alternatively, the module may also be a chip mounted on a card or blade. Meanwhile, the RF circuit 2127 may include, for example, a mixer, a filter, and an amplifier, and transmit and receive wireless signals via the antenna 2110. Although FIG. 11 illustrates an example in which one RF circuit 2127 is connected to one antenna 2110, the present disclosure is not limited to this illustration, instead one RF circuit 2127 may be connected to multiple antennas 2110 at the same time.

As shown in FIG. 11, the wireless communication interface 2125 may include multiple BB processors 2126. For example, multiple BB processors 2126 may be compatible with multiple frequency bands used by gNB 2100. As shown in FIG. 11, the wireless communication interface 2125 may include multiple RF circuits 2127. For example, the multiple RF circuits 2127 may be compatible with multiple antenna elements. Although FIG. 11 illustrates an example in which the wireless communication interface 2125 includes multiple BB processors 2126 and multiple RF circuits 2127, the wireless communication interface 2125 may also include a single BB processor 2126 or a single RF circuit 2127.

### Second Example

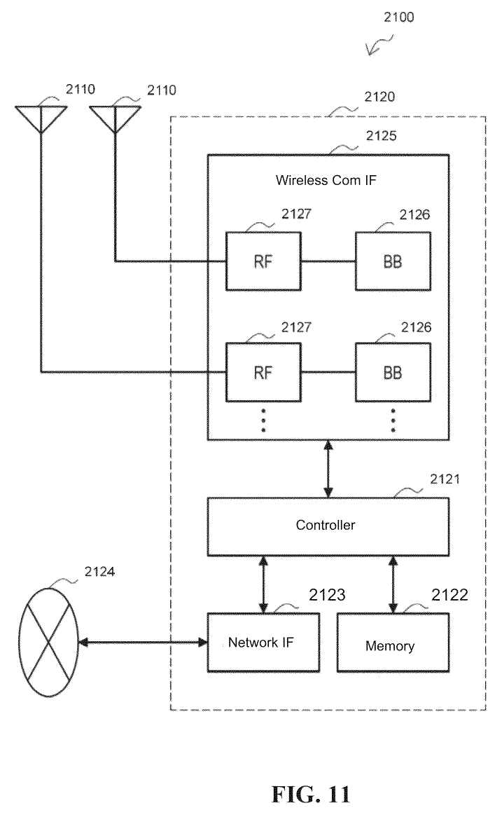

FIG. 12 is a block diagram showing a second example of a schematic configuration of a gNB to which the technology of the present disclosure may be applied. The gNB 2200 includes multiple antennas 2210, RRH 2220 and base station device 2230. The RRH 2220 and each antenna 2210 may be connected to each other via an RF cable. The base station device 2230 and the RRH 2220 may be connected to each other via a high-speed line such as an optical fiber cable. In one implementation, the gNB 2200 (or the base station device 2230) here may correspond to the above electronic device on the control side.

Each of the antennas 2210 includes a single or multiple antenna elements (such as multiple antenna elements included in a MIMO antenna), and is used for the RRH 2220 to send and receive wireless signals. As shown in FIG. 12, the gNB 2200 may include multiple antennas 2210. For example, the multiple antennas 2210 may be compatible with multiple frequency bands used by the gNB 2200.

The base station device 2230 includes a controller 2231, a memory 2232, a network interface 2233, a wireless communication interface 2234 and a connection interface 2236. The controller 2231, the memory 2232, and the network interface 2233 are the same as the controller 2121, the memory 2122, and the network interface 2123 described with reference to FIG. 11.

The wireless communication interface 2234 supports any cellular communication scheme (such as LTE and LTE-Advanced), and provides wireless communication to terminals located in a sector corresponding to the RRH 2220 via the RRH 2220 and the antenna 2210. The wireless communication interface 2234 may generally include, for example, a BB processor 2235. The BB processor 2235 is the same as the BB processor 2126 described with reference to FIG. 11 except that the BB processor 2235 is connected to the RF circuit 2222 of the RRH 2220 via the connection interface 2236. As shown in FIG. 12, the wireless communication interface 2234 may include multiple BB processors 2235. For example, the multiple BB processors 2235 may be compatible with multiple frequency bands used by the gNB 2200. Although FIG. 12 illustrates an example in which the wireless communication interface 2234 includes multiple BB processors 2235, the wireless communication interface 2234 may also include a single BB processor 2235.

The connection interface 2236 is an interface for connecting the base station device 2230 (wireless communication interface 2234) to the RRH 2220. The connection interface 2236 may also be a communication module for communication in the above high-speed line connecting the base station device 2230 (wireless communication interface 2234) to the RRH 2220.

The RRH 2220 includes a connection interface 2223 and a wireless communication interface 2221.

The connection interface 2223 is an interface for connecting the RRH 2220 (wireless communication interface 2221) to the base station device 2230. The connection interface 2223 may also be a communication module used for communication in the above high-speed line.

The wireless communication interface 2221 transmits and receives wireless signals via the antenna 2210. Wireless communication interface 2221 may generally include RF circuitry 2222, for example. The RF circuit 2222 may include, for example, a mixer, a filter, and an amplifier, and transmits and receives wireless signals via the antenna 2210. Although FIG. 12 shows an example in which one RF circuit 2222 is connected to one antenna 2210, the present disclosure is not limited to this illustration, instead one RF circuit 2222 may be connected to multiple antennas 2210 at the same time.

As shown in FIG. 12, the wireless communication interface 2221 may include multiple RF circuits 2222. For example, the multiple RF circuits 2222 may support multiple antenna elements. Although FIG. 12 illustrates an example in which the wireless communication interface 2221 includes multiple RF circuits 2222, the wireless communication interface 2221 may also include a single RF circuit 2222.

### [Examples of User Device/Terminal Device]

### First Example

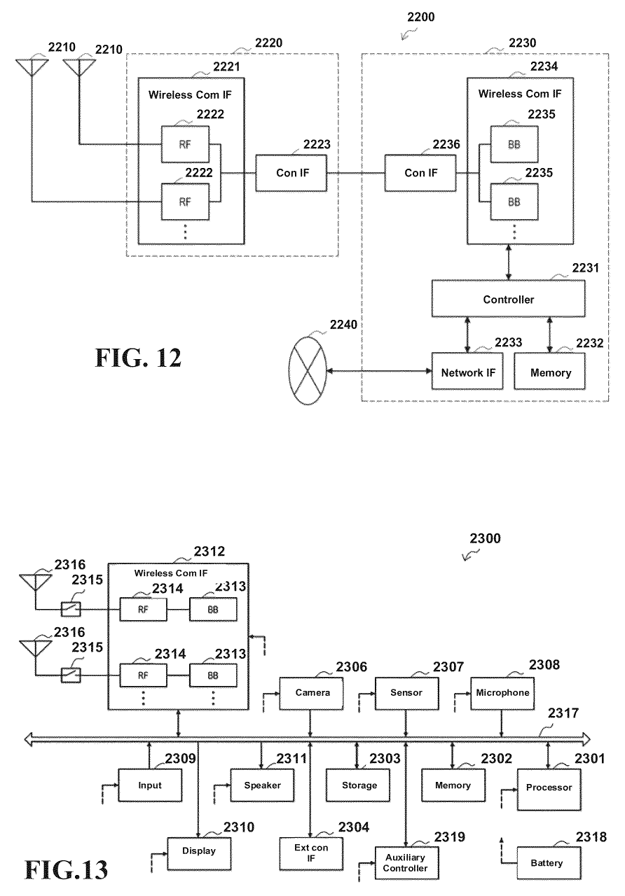

FIG. 13 is a block diagram showing an example of a schematic configuration of a communication device 2300 (e.g., a smart phone, a communicator, etc.) to which the techniques of the present disclosure may be applied. The communication device 2300 includes a processor 2301, a memory 2302, a storage apparatus 2303, an external connection interface 2304, a camera apparatus 2306, a sensor 2307, a microphone 2308, an input apparatus 2309, a display apparatus 2310, a speaker 2311, a wireless communication interface 2312, one or more antenna switches 2315, one or more antennas 2316, a bus 2317, a battery 2318, and an auxiliary controller 2319. In one implementation, the communication device 2300 (or the processor 2301) here may correspond to the above transmitting device or electronic device on the terminal side.

The processor 2301 may be, for example, a CPU or a system on chip (SoC), and controls functions of an application layer and other layers of the communication device 2300. The memory 2302 includes RAM and ROM, and stores data and programs executed by the processor 2301. The storage apparatus 2303 may include a storage medium such as a semiconductor memory and a hard disk. The external connection interface 2304 is an interface for connecting an external apparatus (such as a memory card and a universal serial bus (USB) apparatus) to the communication device 2300.

The camera apparatus 2306 includes an image sensor (such as a charge coupled device (CCD) and a complementary metal oxide semiconductor (CMOS)), and generates a captured image. Sensors 2307 may include a set of sensors such as measurement sensors, gyro sensors, geomagnetic sensors, and acceleration sensors. The microphone 2308 converts sound input to the communication device 2300 into an audio signal. The input apparatus 2309 includes, for example, a touch sensor configured to detect a touch on the screen of the display apparatus 2310, a keypad, a keyboard, buttons, or switches, and receives operations or information input from a user. The display apparatus 2310 includes a screen (such as a Liquid Crystal Display (LCD) and an Organic Light Emitting Diode (OLED) display), and displays an image output by the communication device 2300. The speaker 2311 converts an audio signal output from the communication device 2300 into sound.

The wireless communication interface 2312 supports any cellular communication scheme (such as LTE and LTE-Advanced), and performs wireless communication. The wireless communication interface 2312 may generally include, for example, a BB processor 2313 and an RF circuit 2314. The BB processor 2313 may perform, for example, encoding/decoding, modulation/demodulation, and multiplexing/demultiplexing, and perform various types of signal processing for wireless communication. Meanwhile, the RF circuit 2314 may include, for example, a mixer, a filter, and an amplifier, and transmit and receive wireless signals via the antenna 2316. The wireless communication interface 2312 may be a chip module on which a BB processor 2313 and an RF circuit 2314 are integrated. As shown in FIG. 13, the wireless communication interface 2312 may include multiple BB processors 2313 and multiple RF circuits 2314. Although FIG. 13 shows an example in which the wireless communication interface 2312 includes multiple BB processors 2313 and multiple RF circuits 2314, the wireless communication interface 2312 may also include a single BB processor 2313 or a single RF circuit 2314.

In addition, the wireless communication interface 2312 may support another type of wireless communication scheme, such as a short-range wireless communication scheme, a near field communication scheme, and a wireless local area network (LAN) scheme, in addition to the cellular communication scheme. In this case, the wireless communication interface 2312 may include a BB processor 2313 and an RF circuit 2314 for each wireless communication scheme.

Each of the antenna switches 2315 switches the connection destination of the antenna 2316 among multiple circuits included in the wireless communication interface 2312 (e.g., circuits for different wireless communication schemes).

Each of the antennas 2316 includes a single or multiple antenna elements (such as multiple antenna elements included in a MIMO antenna), and is used for the wireless communication interface 2312 to transmit and receive wireless signals. As shown in FIG. 13, the communication device 2300 may include multiple antennas 2316. Although FIG. 13 illustrates an example in which the communication device 2300 includes multiple antennas 2316, the communication device 2300 may also include a single antenna 2316.

In addition, the communication device 2300 may include an antenna 2316 for each wireless communication scheme. In this case, the antenna switch 2315 may be omitted from the configuration of the communication device 2300.

The bus 2317 connects the processor 2301, memory 2302, storage apparatus 2303, external connection interface 2304, camera apparatus 2306, sensor 2307, microphone 2308, input apparatus 2309, display apparatus 2310, speaker 2311, wireless communication interface 2312, and auxiliary controller 2319 to each other. The battery 2318 provides power to the various blocks of the communication device 2300 shown in FIG. 13 via feed lines, which are partially shown as dashed lines in the figure. The auxiliary controller 2319 operates the minimum necessary functions of the communication device 2300 in sleep mode, for example.

### Second Example

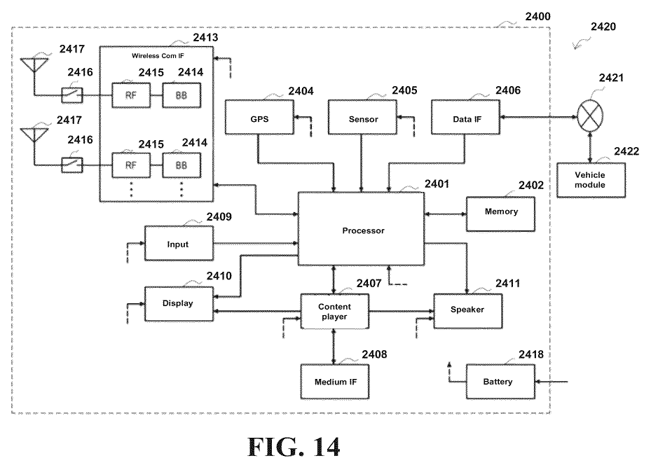

FIG. 14 is a block diagram showing an example of a schematic configuration of a vehicle navigation device 2400 to which the technology of the present disclosure may be applied. The vehicle navigation device 2400 includes a processor 2401, a memory 2402, a global positioning system (GPS) module 2404, a sensor 2405, a data interface 2406, a content player 2407, a storage medium interface 2408, an input apparatus 2409, a display apparatus 2510, a speaker 2411, a wireless communication interface 2413, one or more antenna switches 2416, one or more antennas 2417, and a battery 2418. In one implementation, the vehicle navigation device 2400 (or the processor 2401) here may correspond to a transmitting device or a terminal-side electronic device.

The processor 2401 may be, for example, a CPU or a SoC, and controls the navigation function and other functions of the vehicle navigation device 2400. The memory 2402 includes RAM and ROM, and stores data and programs executed by the processor 2401.

The GPS module 2404 measures the location (such as latitude, longitude, and altitude) of the vehicle navigation device 2400 using GPS signals received from GPS satellites. The sensors 2405 may include a set of sensors such as gyroscopic sensors, geomagnetic sensors, and air pressure sensors. The data interface 2406 is connected to, for example, the in-vehicle network 2421 via a terminal not shown, and acquires data generated by the vehicle (such as vehicle speed data).

The content player 2407 reproduces content stored in a storage medium (such as CD and DVD), which is inserted into the storage medium interface 2408. The input apparatus 2409 includes, for example, a touch sensor configured to detect a touch on the screen of the display apparatus 2510, a button, or a switch, and receives an operation or information input from a user. The display apparatus 2510 includes a screen such as an LCD or OLED display, and displays an image of a navigation function or reproduced content. The speaker 2411 outputs sound of a navigation function or reproduced content.

The wireless communication interface 2413 supports any cellular communication scheme such as LTE and LTE-Advanced, and performs wireless communication. The wireless communication interface 2413 may generally include, for example, a BB processor 2414 and an RF circuit 2415. The BB processor 2414 may perform, for example, encoding/decoding, modulation/demodulation, and multiplexing/demultiplexing, and perform various types of signal processing for wireless communication. Meanwhile, the RF circuit 2415 may include, for example, a mixer, a filter, and an amplifier, and transmit and receive wireless signals via the antenna 2417. The wireless communication interface 2413 may also be a chip module on which the BB processor 2414 and the RF circuit 2415 are integrated. As shown in FIG. 14, the wireless communication interface 2413 may include multiple BB processors 2414 and multiple RF circuits 2415. Although FIG. 14 illustrates an example in which the wireless communication interface 2413 includes multiple BB processors 2414 and multiple RF circuits 2415, the wireless communication interface 2413 may also include a single BB processor 2414 or a single RF circuit 2415.

In addition, the wireless communication interface 2413 may support another type of wireless communication scheme, such as a short-distance wireless communication scheme, a near field communication scheme, and a wireless LAN scheme, in addition to the cellular communication scheme. In this case, the wireless communication interface 2413 may include a BB processor 2414 and an RF circuit 2415 for each wireless communication scheme.

Each of the antenna switches 2416 switches the connection destination of the antenna 2417 among multiple circuits included in the wireless communication interface 2413 (such as circuits for different wireless communication schemes).

Each of the antennas 2417 includes a single or multiple antenna elements (such as multiple antenna elements included in a MIMO antenna), and is used for the wireless communication interface 2413 to transmit and receive wireless signals. As shown in FIG. 14, the vehicle navigation device 2400 may include multiple antennas 2417. Although FIG. 14 illustrates an example in which the vehicle navigation device 2400 includes multiple antennas 2417, the vehicle navigation device 2400 may also include a single antenna 2417.

In addition, the vehicle navigation device 2400 may include an antenna 2417 for each wireless communication scheme. In this case, the antenna switch 2416 may be omitted from the configuration of the vehicle navigation device 2400.

The battery 2418 provides power to various blocks of the vehicle navigation device 2400 shown in FIG. 14 via feeder lines, which are partially shown as dotted lines in the figure. The battery 2418 accumulates electric power supplied from the vehicle.

The technology of the present disclosure may also be implemented as an in-vehicle system (or vehicle) 2420 including one or more blocks in a vehicle navigation device 2400, an in-vehicle network 2421, and a vehicle module 2422. The vehicle module 2422 generates vehicle data (such as vehicle speed, engine speed, and breakdown information), and outputs the generated data to the in-vehicle network 2421.

The exemplary embodiments of the present disclosure are described above with reference to the accompanying drawings, but the present disclosure is of course not limited to the above examples. A person skilled in the art may find various alterations and modifications within the scope of the appended claims, and it should be understood that they will naturally come under the technical scope of the present disclosure.

It should be understood that the machine-readable storage medium or the machine-executable instructions in the program product according to the embodiments of the present disclosure may be configured to perform operations corresponding to the above device and method embodiments. When referring to the above device and method embodiments, the embodiments of the machine-readable storage medium or the program product will be obvious to those skilled in the art, so the description will not be repeated. Machine-readable storage media and program products for carrying or including the above machine-executable instructions also fall within the scope of the present disclosure. Such storage media may include, but are not limited to, floppy disks, optical disks, magneto-optical disks, memory cards, memory sticks, and the like.

In addition, it should be understood that the series of processes and devices described above may also be implemented by software and/or firmware. In the case of implemented by software and/or firmware, respective programs constituting the respective software are stored in the storage medium of the related device, and various functions may be performed when the programs are executed.

For example, multiple functions included in one unit in the above embodiments may be implemented by separate apparatus. Alternatively, multiple functions implemented by multiple units in the above embodiments may be respectively implemented by separate apparatus. In addition, one of the above functions may be realized by multiple units. Needless to say, such a configuration is included in the technical scope of the present disclosure.

In this specification, the steps described in the flowcharts include not only processing performed in time series in the stated order but also processing performed in parallel or individually and not necessarily in time series. Furthermore, even in the steps processed in time series, needless to say, the order may be appropriately changed.

### 4. EXEMPLARY EMBODIMENTS OF THE PRESENT DISCLOSURE

According to the embodiments of the present disclosure, various exemplary implementations for realizing the concepts of the present disclosure may be conceived, including but not limited to the following embodiments:

1. An electronic device used with a base station, the electronic device comprising:
a processing circuit, configured to:
   cause a first set of intelligent surfaces to reflect a set of first reflected beams to be used for a first beam scanning with a user equipment (UE);
   cause a second set of intelligent surfaces to reflect a set of second reflected beams to be used for a second beam scanning with the UE, wherein the second set of intelligent surfaces is selected from the first set of intelligent surfaces, and a beam width for the set of second reflected beams is smaller than a beam width for the set of first reflected beams; and
   determine a position of the UE, based at least in part on a result of the second beam scanning.

2. The electronic device of Embodiment 1, wherein the first set of intelligent surfaces is selected based at least in part on initial position information of the UE.

3. The electronic device of Embodiment 1, wherein the first beam scanning comprises:
for each intelligent surface of the first set of intelligent surfaces, determining, from the set of first reflected beams, a first positioning beam that has a maximum received power at the UE.

4. The electronic device of Embodiment 1, wherein at least one of the second set of intelligent surfaces or the set of second reflected beams is determined based at least in part on a result of the first beam scanning.

5. The electronic device of Embodiment 1, wherein the second beam scanning comprises:
for each intelligent surface in the second set of intelligent surfaces, determining, from the set of second reflected beams, a second positioning beam that has a maximum received power at the UE.

6. The electronic device of Embodiment 5, wherein the position of the UE is determined based at least in part on the second positioning beam.

7. The electronic device of Embodiment 6, wherein the processing circuit is further configured to select a positioning mode for the UE from:
a first positioning mode, in which the set of first reflected beams and the set of second reflected beams are formed based on a radio signal transmitted by the base station; or
a second positioning mode, in which the set of first reflected beams and the set of second reflected beams are formed based on a radio signal transmitted by an assisting UE that is different from the UE.

8. The electronic device of Embodiment 7, wherein the positioning mode is selected based on at least one of: capability of the UE, a connection state of a sidelink of the UE, and quality of service for the UE.

9. The electronic device of Embodiment 7, wherein the processing circuit is further configured to:
in response to a selection of the first positioning mode, determine the position of the UE based on multiple second positioning beams that are determined for multiple intelligent surfaces of the second set of intelligent surfaces.

10. The electronic device of Embodiment 7, wherein the processing circuit is further configured to:
in response to a selection of the second positioning mode, determine the position of the UE based on: a distance between the UE and the assisting UE, and at least one second positioning beam that is determined for at least one intelligent surface of the second intelligent surface set.

11. The electronic device of Embodiment 10, wherein the distance between the UE and the assisting UE is determined based on a sidelink signal between the assisting UE and the UE.

12. An electronic device used with a user equipment (UE), the electronic device comprising:
a processing circuit, configured to:
   receive a set of first reflected beams reflected from a first set of intelligent surfaces to perform a first beam scanning;
   receive a set of second reflected beams reflected from a second set of intelligent surfaces to perform a second beam scanning, wherein the second set of intelligent surfaces is selected from the first set of intelligent surfaces, and a beam width for the set of second reflected beams is smaller than a beam width for the set of first reflected beams; and
   acquire a position of the UE that is determined based at least in part on a result of the second beam scanning.

13. The electronic device of Embodiment 12, wherein the first beam scanning comprises:
for each intelligent surface of the first set of intelligent surfaces, determining, from the set of first reflected beams, a first positioning beam that has a maximum received power at the UE.

14. The electronic device of Embodiment 12, wherein the second beam scanning comprises:
for each intelligent surface in the second set of intelligent surfaces, determining, from the set of second reflected beams, a second positioning beam that has a maximum received power at the UE.

15. The electronic device of Embodiment 12, wherein the position of the UE is determined based at least in part on the second positioning beam.

16. The electronic device of Embodiment 15, wherein the processing circuit is further configured to receive a positioning mode selected for the UE, the positioning mode being selected from:
a first positioning mode, in which the set of first reflected beams and the set of second reflected beams are formed based on a radio signal transmitted by a base station; or
a second positioning mode, in which the set of first reflected beams and the set of second reflected beams are formed based on a radio signal transmitted by an assisting UE that is different from the UE.

17. The electronic device of Embodiment 16, wherein the processing circuit is further configured to:
report at least one of capability of the UE, a connection state of a sidelink of the UE, and quality of service for the UE, for selecting the positioning mode.

18. The electronic device of Embodiment 20, wherein the processing circuit is further configured to:
in the second positioning mode, communicate a sidelink signal between the assisting UE and the UE.

19. A method performed by an electronic device on a base station side, comprising:
causing a first set of intelligent surfaces to reflect a set of first reflected beams to be used for a first beam scanning with a user equipment (UE);
causing a second set of intelligent surfaces to reflect a set of second reflected beams to be used for a second beam scanning with the UE, wherein the second set of intelligent surfaces is selected from the first set of intelligent surfaces, and a beam width for the set of second reflected beams is smaller than a beam width for the set of first reflected beams; and
determining a position of the UE, based at least in part on a result of the second beam scanning.

20. A method performed by an electronic device on a user equipment (UE) side, comprising:
receiving a set of first reflected beams reflected from a first set of intelligent surfaces to perform a first beam scanning;
receiving a set of second reflected beams reflected from a second set of intelligent surfaces to perform a second beam scanning, wherein the second set of intelligent surfaces is selected from the first set of intelligent surfaces, and a beam width for the set of second reflected beams is smaller than a beam width for the set of first reflected beams; and
acquiring a position of the UE that is determined based at least in part on a result of the second beam scanning

1. An electronic device used with a base station, the electronic device comprising:
at least one processor; and
at least one memory including computer program code, where the at least one memory and the computer program code are configured, with the at least one processor, to cause the electronic device to:
cause a first set of intelligent surfaces to reflect a set of first reflected beams to be used for a first beam scanning with a user equipment (UE);
cause a second set of intelligent surfaces to reflect a set of second reflected beams to be used for a second beam scanning with the UE, wherein the second set of intelligent surfaces is selected from the first set of intelligent surfaces, and a beam width for the set of second reflected beams is smaller than a beam width for the set of first reflected beams; and
determine a position of the UE, based at least in part on a result of the second beam scanning.

2. The electronic device of claim 1, wherein the first set of intelligent surfaces is selected based at least in part on initial position information of the UE.

3. The electronic device of claim 1, wherein the first beam scanning comprises:
for each intelligent surface of the first set of intelligent surfaces, determining, from the set of first reflected beams, a first positioning beam that has a maximum received power at the UE.

4. The electronic device of claim 1, wherein at least one of the second set of intelligent surfaces or the set of second reflected beams is determined based at least in part on a result of the first beam scanning.

5. The electronic device of claim 1, wherein the second beam scanning comprises:
for each intelligent surface in the second set of intelligent surfaces, determining, from the set of second reflected beams, a second positioning beam that has a maximum received power at the UE.

6. The electronic device of claim 5, wherein the position of the UE is determined based at least in part on the second positioning beam.

7. The electronic device of claim 6, wherein the at least one memory and the computer program code are configured, with the at least one processor, to cause the electronic device to further select a positioning mode for the UE from:
a first positioning mode, in which the set of first reflected beams and the set of second reflected beams are formed based on a radio signal transmitted by the base station; or
a second positioning mode, in which the set of first reflected beams and the set of second reflected beams are formed based on a radio signal transmitted by an assisting UE that is different from the UE.

8. The electronic device of claim 7, wherein the positioning mode is selected based on at least one of: capability of the UE, a connection state of a sidelink of the UE, and quality of service for the UE.

9. The electronic device of claim 7, wherein the at least one memory and the computer program code are configured, with the at least one processor, to cause the electronic device to further:
in response to a selection of the first positioning mode, determine the position of the UE based on multiple second positioning beams that are determined for multiple intelligent surfaces of the second set of intelligent surfaces.

10. The electronic device of claim 7, wherein the at least one memory and the computer program code are configured, with the at least one processor, to cause the electronic device to further:
in response to a selection of the second positioning mode, determine the position of the UE based on: a distance between the UE and the assisting UE, and at least one second positioning beam that is determined for at least one intelligent surface of the second intelligent surface set.

11. The electronic device of claim 10, wherein the distance between the UE and the assisting UE is determined based on a sidelink signal between the assisting UE and the UE.

12. An electronic device used with a user equipment (UE), the electronic device comprising:
at least one processor; and
at least one memory including computer program code, where the at least one memory and the computer program code are configured, with the at least one processor, to cause the electronic device to:
receive a set of first reflected beams reflected from a first set of intelligent surfaces to perform a first beam scanning;
receive a set of second reflected beams reflected from a second set of intelligent surfaces to perform a second beam scanning, wherein the second set of intelligent surfaces is selected from the first set of intelligent surfaces, and a beam width for the set of second reflected beams is smaller than a beam width for the set of first reflected beams; and
acquire a position of the UE that is determined based at least in part on a result of the second beam scanning.

13. The electronic device of claim 12, wherein the first beam scanning comprises:
for each intelligent surface of the first set of intelligent surfaces, determining, from the set of first reflected beams, a first positioning beam that has a maximum received power at the UE.

14. The electronic device of claim 12, wherein the second beam scanning comprises:
for each intelligent surface in the second set of intelligent surfaces, determining, from the set of second reflected beams, a second positioning beam that has a maximum received power at the UE.

15. The electronic device of claim 12, wherein the position of the UE is determined based at least in part on the second positioning beam.

16. The electronic device of claim 15, wherein the at least one memory and the computer program code are configured, with the at least one processor, to cause the electronic device to further receive a positioning mode selected for the UE, the positioning mode being selected from:
a first positioning mode, in which the set of first reflected beams and the set of second reflected beams are formed based on a radio signal transmitted by a base station; or
a second positioning mode, in which the set of first reflected beams and the set of second reflected beams are formed based on a radio signal transmitted by an assisting UE that is different from the UE.

17. The electronic device of claim 16, wherein the at least one memory and the computer program code are configured, with the at least one processor, to cause the electronic device to further:
report at least one of capability of the UE, a connection state of a sidelink of the UE, and quality of service for the UE, for selecting the positioning mode.

18. The electronic device of claim 12, wherein the at least one memory and the computer program code are configured, with the at least one processor, to cause the electronic device to further:
in the second positioning mode, communicate a sidelink signal between the assisting UE and the UE.

19. A method performed by an electronic device on a base station side, comprising:
causing a first set of intelligent surfaces to reflect a set of first reflected beams to be used for a first beam scanning with a user equipment (UE);
causing a second set of intelligent surfaces to reflect a set of second reflected beams to be used for a second beam scanning with the UE, wherein the second set of intelligent surfaces is selected from the first set of intelligent surfaces, and a beam width for the set of second reflected beams is smaller than a beam width for the set of first reflected beams; and
determining a position of the UE, based at least in part on a result of the second beam scanning.

20. A method performed by an electronic device on a user equipment (UE) side, comprising:
receiving a set of first reflected beams reflected from a first set of intelligent surfaces to perform a first beam scanning;
receiving a set of second reflected beams reflected from a second set of intelligent surfaces to perform a second beam scanning, wherein the second set of intelligent surfaces is selected from the first set of intelligent surfaces, and a beam width for the set of second reflected beams is smaller than a beam width for the set of first reflected beams; and
acquiring a position of the UE that is determined based at least in part on a result of the second beam scanning.
